(19) United States
(12) Patent Application Publication
(10) Pub. No.: US 2023/0281432 A1
(43) Pub. Date: Sep. 7, 2023

(54) SYSTEM AND METHOD FOR HYBRID ARITHMETIC AND LOGIC PROCESSING OF NEURAL NETWORKS

(71) Applicant: University of Southern California, Los Angeles, CA (US)

(72) Inventors: Mahdi NAZEMI, San Francisco, CA (US); Arash FAYYAZI, Los Angeles, CA (US); Amirhossein ESMAILI, Los Angeles, CA (US); Massoud PEDRAM, Beverly Hills, CA (US)

(73) Assignee: University of Southern California, Los Angeles, CA (US)

(21) Appl. No.: 18/086,989

(22) Filed: Dec. 22, 2022

Related U.S. Application Data
(60) Provisional application No. 63/293,500, filed on Dec. 23, 2021.

(51) Int. Cl. G06N 3/048; G06F 7/544

(52) U.S. Cl. CPC G06N 3/048; G06F 7/5443

(57) ABSTRACT

A hybrid processing fabric for doing training and inference on neural networks comprises heterogeneous computational resources for performing both arithmetic and logic operations such that some layers of the neural network are implemented with arithmetic multiply-and-accumulate processing elements whereas other layers are implemented with fixed-function logic processing elements. Support circuitry including memory, data transformation modules, and I/O interfaces are also included in the fabric. A compiler is introduced to optimize and map high level descriptions of the neural network model to the said hybrid fabric.

### CROSS-REFERENCE TO RELATED APPLICATIONS

This application claims the benefit of U.S. provisional application Serial No. 63/293,500 filed Dec. 23, 2021, the disclosure of which is hereby incorporated in its entirety by reference herein.

### TECHNICAL FIELD

In at least one aspect, the present invention relates to neural network acceleration and in particular to a heterogeneous computational fabric and associated compiler for processing neural networks.

### BACKGROUND

Artificial neural networks (ANNs) constitute a class of machine learning models which are inspired by biological neural networks. An ANN is comprised of artificial neurons and synaptic connections. Each artificial neuron (neuron, for short) receives information from its input synaptic connections, processes the information, and produces an output which is consumed by neurons connected to its output synaptic connections. On the other hand, each synaptic connection (called an edge) determines the strength of the connection between its producer and consumer neurons using a weight value.

The first mathematical model of an artificial neuron was presented by Warren S. McCulloch and Walter Pitts in 1943 [38]. A McCulloch-Pitts neuron (a.k.a. the threshold logic unit) takes a number of binary excitatory inputs and a binary inhibitory input, compares the sum of excitatory inputs with a threshold, and produces a binary output of one if the sum exceeds the threshold and the inhibitory input is not set. More formally,

$$y = \left\{\begin{matrix}1 & \text{if} {\sum }_{i = 1}^{n - 1} {x}_{i} \geq b \text{and} {x}_{0} = 0 \\ 0 & \text{otherwise,}\end{matrix}\right)$$

where each xᵢ represents one of the n binary inputs (x₀ is the inhibitory input while the remaining inputs are excitatory), b is the threshold (a.k.a. bias), and y is the binary output of the neuron. It is evident that a McCulloch-Pitts neuron can easily implement various logical operations such as the logical conjunction (AND), the logical disjunction (OR), and the logical negation (NOT) by setting appropriate thresholds and inhibitory inputs. As a result, any arbitrary Boolean function can be mapped to an ANN that is comprised of McCulloch-Pitts neurons. One of the main shortcomings of McCulloch-Pitts neurons is the absence of weights which determine the strength of synaptic connections between neurons.

A perceptron, which was first proposed by Frank Rosenblatt in 1958 [47], addresses some of the shortcomings of McCulloch-Pitts neurons by introducing tunable weights and allowing real-valued inputs. The output of a perceptron is found by

$$y = \left\{\begin{matrix}0 & \text{(1)} {\sum }_{i = 0}^{n - 1} {w}_{i} {x}_{i} < b \\ 1 & \text{if} {\sum }_{i = 0}^{n - 1} {w}_{i} {x}_{i} \geq b\end{matrix}\right) = H \left(w ⋅ x - b\right) ,$$

where each wᵢ determines the strength of its corresponding input xᵢ, w · x is the dot product of weights and inputs¹, and H(·̇) is the Heaviside step function.

¹ Please note that

$$\sum {}_{i = 0}^{n - 1}$$

wᵢxᵢ is replaced with the dot product of w and x for conciseness.

A learning algorithm adjusts values of weights such that they form a decision boundary that perfectly segregates linearly-separable data. To allow the direct use of gradient descent and other optimization methods for tuning weights, the Heaviside step function can be replaced with a differentiable nonlinear function such as the logistic function, hyperbolic tangent function, and rectifier² [24]. As a result, the output of a neuron can be written as

$$y = ϕ \left(w ⋅ x - b\right) , \qquad \text{(2)}$$

where ϕ(·) represents the nonlinear function (a.k.a. the activation function). In this new equation, outputs can assume any real value defined in the range of the activation function. The outputs are usually referred to as activations.

² A unit employing the rectifier is referred to as a rectified linear unit (ReLU).

To enable effective segregation of nonlinear data, perceptrons are organized into multiple layers where each layer includes several neurons and each neuron in a layer is connected to all neurons in the previous layer (except for neurons in the first layer which are directly connected to inputs). Such an ANN is referred to as a multilayer perceptron (MLP) and each layer is referred to as a linear (a.k.a. fully-connected) layer. FIG. 3 illustrates an MLP with four neurons 301 in its input layer 303, three neurons in each of its two intermediate (a.k.a. hidden) layers 305, and a single neuron in its output layer 304.

MLPs are typically trained through the backpropagation algorithm. Backpropagation efficiently computes the gradient of a loss function, which measures the deviation of predicted output from the ground truth, with respect to the weights of the network. This is achieved by applying the chain rule to compute the gradients, iterating backward from the last layer to avoid redundant calculations of intermediate terms in the chain rule. The aforesaid efficient calculation of gradients makes it feasible to use gradient descent optimization for updating the weights to minimize loss.

While MLPs have proven successful in a variety of applications, other classes of ANNs may be better suited for many other application domains. For example, convolutional neural networks (CNNs) have become the de facto standard for solving various computer vision tasks such as image classification, object detection, and semantic segmentation.

Each layer in a CNN is comprised of multiple three-dimensional (3-D) trainable filters which are applied to different patches of a three-dimensional input. A layer is typically described by its kernel width and height (wₖ and hₖ), number of input channels (cᵢₙ), number of filters (cₒᵤₜ), stride (s), and padding (p). Each 3-D filter raster scans an input volume³ (a.k.a. input feature maps) along its width and height dimensions with a stride s, applies (2) to each visited input volume of wₖ × hₖ × cᵢₙ to generate different output pixels, and produces a two-dimensional (2-D) output channel (a.k.a. output feature map) comprised of the said pixels. The output volume, which is the input volume to the next layer, is found by stacking the 2-D output channels of all cₒᵤₜ 3-D filters along a third dimension.

³ The input volume may be zero -padded by p along its width and height dimensions.

Assuming that the input width is represented with wᵢₙ, the output width wₒᵤₜ can be calculated by

$${W}_{\text{out}} = \left⌊\frac{{w}_{i n} - {w}_{\text{k}} + 2 p}{s}\right⌋ + 1. \qquad \text{(3)}$$

Similarly, the output height hₒᵤₜ can be found given hᵢₙ. FIG. 4 illustrates a convolutional layer 300 where the input volume is 5 × 5 × 3, the padding is zero, the kernel size is 3 × 3, the stride is one, the number of filters is four; therefore, the output volume is 3 × 3 × 4. Notice that a linear layer is in fact a convolutional layer with wₖ = hₖ = 1, cₒᵤₜ filters each of which corresponds to an output neuron, s = 1, p = 0, and an input volume of 1 × 1 × cᵢₙ, where each one of cᵢₙ input channels corresponds to an input neuron.

CNNs may include other types of layers such as max pooling or average pooling layers. Pooling layers implement non-linear down-sampling of individual feature maps by partitioning them into non-overlapping regions of size wₚ × hₚ⁴ and calculating the max or average functions over each region. A by-product of pooling is the progressive reduction in the size of feature maps.

⁴ Typically, wᵢₙ = hᵢₙ, wₒᵤₜ = hₒᵤₜ, wₖ = hₖ, wₖ ≤ wᵢₙ, hₖ ≤ hᵢₙ, and wₚ = hₚ.

Another type of layer which is commonly used in MLPs and CNNs is the batch normalization layer [31]. A batch normalization layer performs centering and scaling on its inputs, which in turn improve the speed, performance, and stability of training and doing inference with DNNs.

Deep neural networks (DNNs) have surpassed the accuracy of conventional machine learning models in many challenging domains including computer vision [29, 33, 42, 45, 55, 67] and natural language processing [15, 26, 28, 30]. Advances in building both general-purpose and custom hardware have been among the key enablers for transforming DNNs from rather theoretical concepts to practical solutions for a wide range of problems [12, 54].

Deep neural networks comprise a number of layers i = 1, ..., N, each layer i contains a number of filters, nᵢ. The layers are connected such that layer i may feed into any layers in front of it, including layers i + 1 to N (e.g., in dense feed-forward networks) although typically the fanout

range of a layer is limited to a small value such as 1 (for simple feed-forward networks) or 2 (for feed-forward networks with skip connections). Each layer receives the input data as input feature maps (input activations) and produces output feature maps (output activations). The first and last layers are special layers where the first layer processes raw input data corresponding to the training or inference data points and the last layer (typically) applies the softmax function to its input activations to produce the classification or forecasting results of the DNN. The other layers may be any of a number of common types such as fully-connected or convolutional. Each of these layers is typically decomposable into a collection of sub-layers, such as tensor computation sub-layer for doing multiply-and-accumulate operations, nonlinear transformation sub-layer for applying activation functions to outputs of the tensor computation sub-layer, batch normalization sub-layer, max pooling sub-layer, etc. as explained above.

A neural network inference task may be run on a variety of platforms ranging from CPU and GPUs to FPGA devices and custom ASICs. A common feature of most of these platforms is that they provide processing elements that are capable of doing an arithmetic multiply-and-accumulate operation on weights and input activations to produce intermediate results that are then acted upon by other processing elements capable of applying a nonlinear transformation to produce the output activations. These platforms are commonly referred to as neural network inference accelerators, machine learning accelerators, or deep learning accelerators.

The arrangement in FIG. 1 shows the block diagram of an exemplary neural network accelerator architecture 100 doing neural network inference. The Neural Network processing unit 105 communicates with a host unit 102 as depicted in FIG. 1. The host unit 102 may comprise one or more processing units (e.g., an x86 central processing unit). As shown in FIG. 1, The host unit 102 may be associated with a host memory 103. In some embodiments, the host memory 103 may be an integrated (on-chip) memory or an external memory associated with the host unit 102. Additionally, the host memory 103 may comprise a host disk, which is an external memory configured to provide additional memory for the host unit 102. The host memory 103 can be a double data rate synchronous dynamic random-access memory (e.g., DDR SDRAM) or the like. The data stored in the host memory 103 is transferred to the accelerator hardware 104 to be executed.

Existing neural network inference accelerators incur a high latency cost and/or use enormous hardware resources which, in turn, prevent their deployment in latency-critical applications, especially on resource-constrained platforms. The arrangement in FIG. 1 shows the block diagram of an exemplary design of a Neural Network Processing Unit 105, in addition to the System Memory 107. The memory system 104 includes a memory 107 and optionally a secondary storage 108. The memory system 104 is responsible for storing the computer programs, or computer control logic algorithms, the input data for the neural network processing circuit 102, the output data generated by the neural network processing circuit 102, and the like. Memory 104 comprises one or more random access memory (RAM) modules. The storage 108 acts as secondary memory and may comprise a hard disk drive, a removable storage drive, or flash memory. The removable storage drive reads from and writes to a removable storage unit as is known by a person skilled in the art. The high latency and large hardware cost emanate from the fact that practical, high-quality deep learning models entail billions of arithmetic operations and millions of parameters, which exert considerable pressure on both the processing and memory subsystems. To sustain the ubiquitous deployment of deep learning models and cope with their high computational and memory complexities, many methods operating at different levels of the design hierarchy have been developed.

The data movement orchestration system 106 in FIG. 2 includes a central processor 108 (e.g., a CPU), and a peripheral bus 107. The central processor 108 in this embodiment is implemented on the same integrated circuit (IC) and is configured to execute program code that performs one or more operations described herein. One function of this orchestration system is to manage the data movements (data flow) between neural network processing circuit 105 and the memory system 108 and/or any other peripheral devices. The central processor 108 may include one or more cores and associated circuitry (e.g., cache memories). The peripheral bus 107 may be implemented based on any of the on-chip bus protocols such as PCI (Peripheral Component Interconnect), PCI-Express, AGP (Accelerated Graphics Port), HyperTransport, or any other bus or point-to-point communication protocol(s).

At the algorithmic level, methods such as model quantization [10, 11, 19, 36, 40, 46], model pruning [16, 25, 34, 37, 41, 62, 63, 68], and knowledge distillation [18, 21, 27, 39, 44, 57, 58] have gained popularity.

Model quantization methods refer to methods for quantizing weights and/or activations during training and inference of neural network models. The data representation formats for the input and output activations varies and can range from full-precision floating point (32 \-bit operands) to half-precision floating point (16 bits) to fixed-point representations (widths between 16 and 8 bits) to 8 or 4 bit integer to binary. In case of the binary representation for weights and activations, the multiply-and-accumulate (MAC) operations are implemented with XNOR and pop count (counting number of 1′s). The arrangement in FIG. 6 shows the block diagram of an exemplary design of a Neural Network Processing Circuit utilizing XNOR and pop count operations for neural network inference task when having binary representation for weights and activations, in addition to the System Memory.

Model pruning is another approach for reducing the memory footprint and computational cost of neural networks, in which filters or subsets of filters with small sensitivity are removed from the network model, resulting in a sparse computational graph. Here, filters are subsets of filters with small sensitivity are those whose removal minimally affects the model or layer output accuracy.

Knowledge or model distillation involves training a large model and then using it as a teacher to train a more compact student model. The loss function employed to train the student model is comprised of two terms. The first term measures the deviation of the predicted output from the ground truth. This term is exactly the same term that is normally used for training neural networks e.g., a log loss (or cross-entropy) function. The second term, on the other hand, measures the deviation of predicted class probabilities of the student model from those of the teacher model. A weighted sum of the two terms is then used as the loss function for model distillation.

To optimize and map a trained neural network model to hardware, a compiler is needed. The compiler is a software program which optimizes and transforms application code describing a neural network inference task into low-level code (hardware-specific instructions) that are executed on a neural network inference accelerator. The compiler typically performs a variety of operations, for example, pre-processing, lexical analysis, parsing, semantic analysis, conversion of input programs to an intermediate representation, initialization of a neural network, low-level code generation, instruction scheduling, data movement management, or combinations thereof. Indeed, many data path and memory optimizations and device-specific code generation techniques targeting machine learning applications have been proposed [1, 4, 5, 35, 49, 60]. At the architecture level, different dataflow architectures (e.g., output stationary and weight stationary dataflows) that support various data reuse schemes have been developed in order to reduce the data movement cost and improve the hardware efficiency of the required neural network computations for a network layer [6, 13, 23, 51, 65, 66]. At the circuit and device levels, various energy-efficient, digital and analog processing components for vector-matrix multiplications have been designed [7-9, 20, 22, 32, 50].

Generally speaking, the CNN accelerator designs on the target device may be divided into two categories [2, 6, 48, 61], single computation engine architectures and streaming architectures. As its name implies, the first approach utilizes a generic accelerator architecture comprising a single computation engine (e.g., a systolic array of MAC units) that is used for the computation of all neural network layers. This approach, which executes the computation of each layer of the CNN for that layer sequentially, sacrifices customization for flexibility. This approach, which has been used in many prior work references [52, 53], is also called a homogeneous design. The streaming architecture, on the other hand, uses one distinct hardware component for each layer where each component is optimized separately to exploit the parallelism in its corresponding layer, constrained by the available resources of the target device [60, 64]. The streaming architecture (a.k.a. heterogeneous design) tends to use more hardware resources, but results in DNN inference with higher throughput compared to the single computation engine architecture.

While there is a large body of work on efficient processing of DNNs [56], energy-efficient, low-latency realization of these models for real-time and latency-critical applications continues to be a complex and challenging problem. A major source of inefficiency in such conventional platforms and data flows is the need to look-up the weights from a weight memory (which may be on or off-chip) and do a MAC operation between the weight and corresponding input activation (which is also read from an on-chip or off-chip input buffer). Expensive are the costs of memory accesses (these are typically large buffers which are located outside the processing element arrays) and full MAC operations. Even in the case of binary representation for weights and activations, where expensive MAC operations are implemented with low-cost XNOR and pop count operations, the overhead of memory accesses for weight look-ups is still significant.

What is needed is an across-the-stack approach for energy-efficient, low-latency processing of neural networks during the inference phase. This solution, which is referred to as HyFEN (Hybrid Framework for Efficient Neural Network Processing), optimizes a target neural network for a given dataset and maps key parts of the required neural network computations to ultra-low-latency, low-cost, fixed-function logic processing elements 2401 which are added to arithmetic processing elements 2501 (e.g., tensor 805 and vector computation units 806) that are typically found in conventional neural network accelerator designs. Examples of such neural network computations are those performed in individual filters one at a time, all filters within one layer, and even all filters within groups of consecutive layers in the DNN. The remaining computations (i.e., those that are not mapped to fixed-function, combinational logic blocks) will be scheduled to run on arithmetic processing elements.

While the idea of converting layers of DNNs to fixed-function, combinational logic (FFCL) followed by the mapping of those blocks to look-up tables (LUTs) has been previously discussed in NullaNet [43] and LogicNets [59], its application has been limited to multilayer perceptrons (MLPs) designed for relatively easy classification tasks. For example, NullaNet applies this idea to MLPs with a few hundred neurons while LogicNets designs MLPs with tens of neurons such that the number of inputs to each neuron is small enough to enable full enumeration of all its input combinations (e.g. fewer than 12 inputs). The arrangement in FIG. 7 shows the block diagram of an exemplary design of an inference accelerator for doing a layer of a neural network using FFCLs. Input feature maps are stored in input buffers 701-1 and are fetched into input registers 702 before FFCLs 703 are applied to them to calculate the output feature map. Next these results are moved to output registers 704 and stored in output buffers 701-2, which function as the input buffers for the next layer.

LogicNets cannot be applied to neural networks where filters in a layer receive hundreds or even thousands of inputs and therefore full enumeration of all input combinations is an impossibility. Moreover, both these techniques rely on Boolean logic function only whereas in many cases multi-valued (say 4 or 8 valued) logic is the right approach. In addition, these prior art techniques tend to result in large output accuracy loss in many neural network applications, a challenge that is successfully addressed by this invention through modifications made to the neural network model itself. Furthermore, both techniques are only capable of optimizing MLPs while CNNs play an important role in many real-world problems. Creating truth tables for CNNs may lead to logic functions with hundreds of thousands to millions of minterms, which cannot be optimized with existing methods. Finally, these prior arts make use of only fixed-function, combinational logic blocks whereas many real-world applications can benefit from heterogeneous computational fabrics comprising MAC-based compute units, XOR/popcount compute units, and custom FFCL compute units. Finally, the prior art references use the FFCL idea only in the context of neural network inference acceleration whereas this idea must be extended and applied to the training of neural networks, as is done in this invention.

### SUMMARY

In at least one aspect, the present inventon overcomes the weaknesses of existing hardware accelerators for neural network training and inference by providing a solution called HyFEN (Hybrid Framework for Efficient Neural Network Processing). The HyFEN solution framework comprises the HyFEN fabric and the HyFEN compiler. The HyFEN fabric is heterogeneous in nature and contains both arithmetic and logic processing element arrays as well as multiple types of memory and routing. Precisely, the HyFEN computational fabric comprises both MAC units and logic processor units organized as two separate but interacting arrays of arithmetic processing elements (APEs) and logic processing elements (LPEs). Optionally, the HyFEN fabric may include an array of processing elements capable of performing XOR-based convolutions (XPEs) as well as other types of processing elements. The HyFEN compiler enables the mapping of a target DNN/CNN to the HyFEN fabric.

In a first embodiment, a circuit for performing neural network computations in a neural network is provided. Characteristically, the circuit is configured with a first plurality of neural network layers and a second plurality of neural network layers. The circuit includes one or more tensor computation units, each tensor computation unit configured to receive a plurality of input weights and a plurality of input activations for neurons in each neural network layer in the first plurality of neural network layers and generate a plurality of accumulated output values for neurons in the first plurality of neural network layers based on the plurality of input weights and the plurality of input activations by doing arithmetic addition and multiplication operations on input connection weights and input activations. The circuit also includes one or more vector computation units coupled to the one or more tensor computation units, each vector computation unit configured to apply a first nonlinear activation function to each value in the plurality of accumulated output values to generate a first plurality of output activations for each neural network layer in the first plurality of neural network layers. The circuit also includes one or more logic computation units, each logic computation unit configured to receive a plurality of Boolean or multi-valued logic input activations for each neural network layer in the second plurality of neural network layers and generate a second plurality of Boolean or multi-valued logic activations for each neural network layer in the second plurality of neural network layers by applying Boolean or multi-valued logic operations on the input activations for each neural network layer in the second plurality of neural network layers.

In an aspect of the first embodiment, one or more layers in the first plurality of neural network layers or the second plurality of neural network layers are of convolutional type.

In another aspect of the first embodiment, the circuit includes one or more matrix computation units coupled to the one or more logic computation units, each matrix computation unit configured to apply an affine transformation followed by a second nonlinear activation function to the second plurality of Boolean or multi-valued logic activations for each neural network layer in the second plurality of neural network layers to generate a third plurality of output activations for each neural network layer in the second plurality of neural network layers.

In another aspect of the first embodiment, the circuit includes one or more signal conversion units existing between a tensor computation unit (or a vector computation unit) of a layer in the first plurality of neural network layers and a logic computation unit of another layer in the second plurality of neural network layers if said two layers feed into one another, each signal conversion unit configured to apply a data transformation between a first data representation domain for the input (or output) activations of the layer in the first plurality of neural network layers and a second representation domain for the output (or input) activations of the layer in the second plurality of neural network layers.

In another aspect of the first embodiment, one or more neurons in one or more of the neural network layers are realized by using standard or custom logic cells in an application-specific integrated circuit, k-input look-up tables in a field programmable gate array device, or gate-level operation commands in a digital signal processor, a graphics processing unit, or a general purpose central processing unit.

In another aspect of the first embodiment, the circuit includes one or more integrated memory units, each memory unit configured to hold any or all input and output activations for each neural network layer.

In another aspect of the first embodiment, one or more neurons in any neural network layers are realized as a weighted linear combination of a number of logic sub-blocks, where each logic sub-block implements a subset of an input-output logic function of the said one or more neurons.

In another aspect of the first embodiment, the number of input activations to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

In another aspect of the first embodiment, least one of the one or more logic computation units is configured to receive the plurality of Boolean or multi-valued logic input activations for a first neural network layer and directly generates the plurality of Boolean or multi-valued logic output activations for a second neural network layer, wherein there may exist zero, one, or more neural network layers between the first neural network layer and the second neural network layer.

In another aspect of the first embodiment, the first neural network layer, the second neural network layer, and all intervening layers between the first neural network layer and the second neural network layer belong to the second plurality of neural network layers.

In a second embodiment, a neural network processing system is provided. The system includes an array of arithmetic processing elements, each processing element configured to perform a subset of addition, multiplication, pooling, normalization, and nonlinear transformation operations for a layer in a first plurality of neural network layers. The system futher includes an array of logic processing elements, each logic processing element configured to perform Boolean or multi-valued logic operations for a layer in a second plurality of neural network layers.

In an aspect of the second embodiment, one of more layers in the first plurality of neural network layers or the second plurality of neural network layers are of convolutional type.

In another aspect of the second embodiment, the circuit further includes one or more data transformation modules existing between the outputs of the array of arithmetic processing elements and the inputs of the array of logic processing elements and vice versa, each data transformation module configured to selectively apply a transformation between data representation domains of the two arrays of processing elements.

In another aspect of the second embodiment, the logic processing elements can be custom fixed-function logic circuits in an application-specific integrated circuit, k-input look-up tables in a field programmable gate array device, or gate-level operation commands in a software-programmable logic processor, a graphics processing unit, or a general purpose central processing unit.

In another aspect of the second embodiment, the system further includes one or more integrated memory units, each memory unit configured to hold any or all input and output values for each neural network layer.

In another aspect of the second embodiment, the number of input values to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

In another aspect of the second embodiment, at least one of the logic processing elements is configured to receive a plurality of Boolean or multi-valued logic input values for a first neural network layer and directly generates a plurality of Boolean or multi-valued logic output values for a second neural network layer, wherein there may exist zero, one, or more neural network layers between the first neural network layer and the second neural network layer.

In another aspect of the second embodiment, the first neural network layer, the second neural network layer, and all intervening layers between the first neural network layer and the second neural network layer belong to the second plurality of neural network layers.

In a third embodiment, a method of optimizing a neural network is provided. The method includes a step of assigning neural network layers to a first plurality or a second plurality of neural network layers. The method also includes a step of producing output activations of a first plurality of neural network layers by performing arithmetic operations, including addition/subtraction and multiplication to do computations of sublayers within the first plurality of neural network layers, including any required linear or convolutional computations, pooling, normalization, and nonlinear transformations. The method also includes a step of producing Boolean or multi-valued output activations of the second plurality of neural network layers by performing Boolean or multi-valued logic operations on Boolean or multi-valued input activations of the second plurality of neural network layers.

In an aspect of the third embodiment, the method comprises the step of selectively converting data representation formats for the output activations of a group of neural network layers that feed directly into a first neural network layer to a required data representation format for the input activations of the first neural network layer.

In another aspect of the third embodiment, an assignment of a neural network layer to the first plurality of neural network layers or the second plurality of neural network layers is done based on a sensitivity analysis of neural network output accuracy to the bit precision of the layer.

In another aspect of the third embodiment, a Boolean or multi-valued function of each neuron in each layer of the second plurality of neural network layers is obtained by
a. constructing a many-to-one mapping relating input activations to the output activation of a neuron; and
b. performing two-level and multi-level logic optimizations to achieve a low-cost representation of the many-to-one mapping.

In another aspect of the third embodiment, the many-to-one mapping for each neuron is obtained by enumerating all possible input activations for the neuron, sampling a training data set for the neural network, or generated synthetically.

In another aspect of the third embodiment, the Boolean or multi-valued function of each neuron describes an incompletely-specified Boolean or multi-valued logic function.

In another aspect of the third embodiment, the many-to-one mapping for each neuron is a truth table whereby each entry in the truth table comprises input activations and an output activation, the input activations are values observed at the inputs of the neuron for each input patch and each data point in the full, sampled, or synthetically-generated training data set and the output activation is produced by doing any required linear or convolutional computations, pooling, normalization, and nonlinear transformation on the input activations.

In another aspect of the third embodiment, the two-level and multi-level logic optimizations are done in such a way that the Boolean or multi-valued logic function of each neuron is only approximately equal to the truth table representation of the neuron.

In another aspect of the third embodiment, the sampling method favors sample selection around the mean value or support vector machine values of the training data set.

In another aspect of the third embodiment, the synthetic method generates new training data based on Data Shapley values of data in the training data set.

In a fourth embodiment, a circuit for performing neural network computations in a neural network that includes a plurality of neural network layers is provided. The circuit includes one or more logic computation units where each logic computation unit configured to receive a plurality of Boolean or multi-valued logic input activations for each neural network layer and generate a plurality of Boolean or multi-valued logic output activations for each neural network layer by applying Boolean or multi-valued logic operations oninput activations for each neural network layer, wherein one of more layers of the neural network are of convolutional type.

In an aspect of the fourth embodiment, one or more neurons in any neural network layers are realized by using standard or custom logic cells in an application-specific integrated circuit, k-input look-up tables in a field programmable gate array device, or gate-level logic operations executed on a custom-made logic processing element, a digital signal processor, a graphics processing unit, or a general purpose central processing unit.

In another aspect of the fourth embodiment, the circuit includes one or more integrated memory units, each memory unit configured to hold any or all input and output activations for each neural network layer.

In another aspect of the fourth embodiment, one or more neurons in any neural network layers are realized as a weighted linear combination of a number of logic sub-blocks, where each logic sub-block implements a subset of input-output logic functions of the said one or more neurons.

In another aspect of the fourth embodiment, the one or more logic computation units execute Boolean or multi-valued logic operations corresponding to Boolean or multi-valued logic functions of a neural network layer, the Boolean or multi-valued logic functions describing logic behaviors of output signal lines carrying the Boolean or multi-valued logic output activations in terms of input signal lines carrying the Boolean or multi-valued logic input activations.

In another aspect of the fourth embodiment, the Boolean or multi-valued logic functions for at least one neural network layer are obtained by two-level and multi-level logic minimization tools.

In another aspect of the fourth embodiment, if the Boolean or multi-valued logic functions for at least one neural network layer are Boolean, each of these functions has an offset size that is larger than its onset size.

In another aspect of the fourth embodiment, the number of input activations to each neuron in one or more neural network layers is upper bounded by a pre-specified input count value for the neuron, where the pre-specified input count value is lower than the number of neurons in the preceding neural network layers that couple into the one or more neural network layers.

In another aspect of the fourth embodiment, the one or more logic computation units additionally perform a maximum pooling operation to calculate the largest value in each patch of a map of output activations of any convolutional layers.

In another aspect of the fourth embodiment, at least one of the one or more logic computation units is configured to receive the plurality of Boolean or multi-valued logic input activations for a first neural network layer and directly generates the plurality of Boolean or multi-valued logic output activations for a second neural network layer, wherein there may exist zero, one, or more neural network layers between the first neural network layer and the second neural network layer.

In a fifth embodiment, a circuit for performing neural network computations in a neural network is provided. Characteristically, the circuit is configured with a first plurality of neural network layers and a second plurality of neural network layers. The circuit includes one or more tensor computation units, each tensor computation unit configured to receive a plurality of input weights and a plurality of input activations for neurons in each neural network layer in the first plurality of neural network layers and generate a plurality of accumulated output values for neurons in the first plurality of neural network layers based on the plurality of input weights and the plurality of input activations by doing arithmetic addition and multiplication operations on input connection weights and input activations. The circuit also includes one or more vector computation units coupled to the one or more tensor computation units, each vector computation unit configured to apply a first nonlinear activation function to each value in the plurality of accumulated output values to generate a first plurality of output activations for each neural network layer in the first plurality of neural network layers. The circuit also includes one or more logic computation units, each logic computation unit configured to receive a plurality of Boolean or multi-valued logic input activations for each neural network layer in the second plurality of neural network layers and generate a second plurality of Boolean or multi-valued logic intermediate activations for each neural network layer in the second plurality of neural network layers by applying Boolean or multi-valued logic operations on the input activations for each neural network layer in the second plurality of neural network layers, wherein one or more layers in the first plurality of neural network layers or the second plurality of neural network layers are of convolutional type.

In an aspect of the fifth embodiment, the circuit includes one or more matrix computation units coupled to the one or more logic computation units, each matrix computation unit configured to apply an affine transformation followed by a second nonlinear activation function to the second plurality of Boolean or multi-valued logic intermediate activations for each neural network layer in the second plurality of neural network layers to generate a third plurality of output activations for each neural network layer in the second plurality of neural network layers.

In another aspect of the fifth embodiment, the circuit includes one or more signal conversion units existing between a tensor computation unit (or a vector computation unit) of a layer in the first plurality of neural network layers and a matrix computation unit (or a logic computation unit) of another layer in the second plurality of neural network layers if said two layers feed into one another, each signal conversion unit configured to apply a data transformation between a first data representation domain for the input (or output) activations of the layer in the first plurality of neural network layers and a second representation domain for the output (or input) activations of the layer in the second plurality of neural network layers.

In another aspect of the fifth embodiment, one or more neurons in one or more of the neural network layers are realized by using standard or custom logic cells in an application-specific integrated circuit, k-input look-up tables in a field programmable gate array device, or gate-level operation commands in a digital signal processor, a graphics processing unit, or a general purpose central processing unit.

In another aspect of the fifth embodiment, the circuit includes one or more integrated memory units, each memory unit configured to hold any or all input and output activations for each neural network layer.

In another aspect of the fifth embodiment, one or more neurons in any neural network layers are realized as a weighted linear combination of a number of logic sub-blocks, where each logic sub-block implements a subset of an input-output logic function of the said one or more neurons.

In another aspect of the fifth embodiment, the one or more logic computation units execute Boolean or multi-valued logic operations corresponding to Boolean or multi-valued logic functions of a neural network layer in the second plurality of neural network layers, the Boolean or multi-valued logic functions describing logic behaviors of output signal lines carrying the output activations in terms of input signal lines carrying the input activations.

In another aspect of the fifth embodiment, the Boolean or multi-valued logic functions for one or more neural network layer in the second plurality of neural network layers are obtained by two-level and multi-level logic minimization tools.

In another aspect of the fifth embodiment, the number of input activations to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

In another aspect of the fifth embodiment, the one or more logic computation units additionally perform a maximum pooling operation to calculate the largest value in each patch of a map of output activations of any convolutional layers.

In another aspect of the fifth embodiment, at least one of the one or more logic computation units is configured to receive the plurality of Boolean or multi-valued logic input activations for a first neural network layer and directly generates the plurality of Boolean or multi-valued logic output activations for a second neural network layer, wherein there may exist zero, one, or more neural network layers between the first neural network layer and the second neural network layer.

In another aspect of the fifth embodiment, the first neural network layer, the second neural network layer, and all intervening layers between the first neural network layer and the second neural network layer belong to the second plurality of neural network layers.

In a sixth embodiment, a circuit for performing neural network computations in a neural network is provided. Characteristically, the circuit configured with a first plurality of neural network layers and a second plurality of neural network layers. The circuit includes one or more tensor computation units, each tensor computation unit configured to receive a plurality of input weights and a plurality of input activations for neurons in each neural network layer in the first plurality of neural network layers and generate a plurality of accumulated output values for neurons in each neural network layer in the first plurality of neural network layers based on the plurality of input weights and the plurality of input activations by doing arithmetic addition and multiplication operations on input connection weights and input activations. The circuit also includes one or more vector computation units coupled to the one or more tensor computation units, each vector computation unit configured to apply a first nonlinear activation function to each value in the plurality of accumulated output values to generate a first plurality of output activations for each neural network layer in the first plurality of neural network layers. The circuit also includes one or more logic computation units, each logic computation unit configured to receive a plurality of Boolean or multi-valued logic input activations for each neural network layer in the second plurality of neural network layers and generate a plurality of Boolean or multi-valued logic intermediate activations for each neural network layer in the second plurality of neural network layers by applying Boolean or multi-valued logic operations on the input activations for each neural network layer in the second plurality of neural network layers. The circuit also includes one or more matrix computation units coupled to the one or more logic computation units, each matrix computation unit configured to apply an affine transformation followed by a second nonlinear activation function to the plurality of Boolean or multi-valued logic intermediate activations to generate a second plurality of output activations for each neural network layer in the second plurality of neural network layers.

In an aspect of the sixth embodiment, each matrix computation unit is configured to apply an identity transformation to the plurality of Boolean or multi-valued logic intermediate activations to generate the second plurality of output activations for each neural network layer in the second plurality of neural network layers.

In another aspect of the sixth embodiment, the first plurality of neural network layers includes one or more convolutional layers.

In another aspect of the sixth embodiment, the circuit includes one or more signal conversion units existing between the one or more tensor computation units (or the one or more vector computation units) of a layer in the first plurality of layers and the one or more matrix computation units (or the logic computation unit) of another layer in the second plurality of layers if said two layers feed into one another, each signal conversion unit configured to apply a data transformation between a first data representation domain for the input (or output) activations of the layer in the first plurality of neural network layers and a second representation domain for the output (or input) activations of the layer in the second plurality of neural network layers.

In another aspect of the sixth embodiment, one or more neurons in one or more of the neural network layers are realized by using standard or custom logic cells in an application-specific integrated circuit, k-input look-up tables in a field programmable gate array device, or gate-level operation commands in a digital signal processor, a graphics processing unit, or a general purpose central processing unit.

In another aspect of the sixth embodiment, the circuit includes one or more integrated memory units, each memory unit configured to hold any or all input and output activations for each neural network layer.

In another aspect of the sixth embodiment, one or more neurons in any neural network layers are realized as a weighted linear combination of a number of logic sub-blocks, where each logic sub-block implements a subset of input-output logic functions of the said one or more neurons.

In another aspect of the sixth embodiment, the one or more logic computation units execute Boolean or multi-valued logic operations corresponding to Boolean or multi-valued logic functions of a neural network layer in the second plurality of neural network layers, the Boolean or multi-valued logic functions describing logic behaviors of output signal lines carrying the output activations in terms of input signal lines carrying the input activations.

In another aspect of the sixth embodiment, the Boolean or multi-valued logic functions for a neural network layer in the second plurality of neural network layers are obtained by two-level and multi-level logic minimization tools.

In another aspect of the sixth embodiment, the number of input activations to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

In another aspect of the sixth embodiment, the one or more logic computation units additionally perform a maximum pooling operation to calculate the largest value in each patch of a map of output activations of any convolutional layers.

In another aspect of the sixth embodiment, at least one of the one or more logic computation units is configured to receive the plurality of Boolean or multi-valued logic input activations for a first neural network layer and directly generates the plurality of Boolean or multi-valued logic output activations for a second neural network layer, wherein there may exist zero, one, or more neural network layers between the first neural network layer and the second neural network layer.

In another aspect of the sixth embodiment, the first neural network layer, the second neural network layer, and all intervening layers between the first neural network layer and the second neural network layer belong to the second plurality of neural network layers.

In a seventh embodiment, a circuit for performing neural network computations in a neural network is porvided. Characteristically, the circuit is configured with a first plurality of neural network layers and a second plurality of neural network layers. The circuit includes one or more tensor computation units, each tensor computation unit configured to receive a plurality of input weights and a plurality of input activations for neurons in each neural network layer in the first plurality of neural network layers and generate a plurality of accumulated output values for neurons in the layer based on the plurality of input weights and the plurality of input activations by doing arithmetic addition and multiplication operations on input connection weights and input activations. The circuit also includes one or more vector computation units coupled to the one or more tensor computation units, each vector computation unit configured to apply a first nonlinear activation function to each value in the plurality of accumulated output values to generate a first plurality of output activations for each neural network layer in the first plurality of neural network layers. The circuit also includes one or more logic computation units, each logic computation unit configured to receive a plurality of Boolean or multi-valued logic input activations for each neural network layer in the second plurality of neural network layers and generate a plurality of Boolean or multi-valued logic intermediate activations for the layer by applying Boolean or multi-valued logic operations on the input activations for the layer. The circuit also includes one or more signal conversion units existing between the output activations of a first layer and the input activations of a second layer in the neural network if the output activations of the first layer have a first data representation format and are coupled to the input activations of the second layer which have a possibly-different second data representation format, each signal conversion unit configured to apply a domain transformation between the first and second data representation formats.

In an aspect of the seventh embodiment, the first and second data representations are the same, and each signal conversion unit is configured to apply an identity transformation between the first data and second representation domains.

In another aspect of the seventh embodiment, the first plurality of neural network layers includes one or more convolutional layers.

In another aspect of the seventh embodiment, the circuit includes one or more matrix computation units coupled to the one or more logic computation units, each matrix computation unit configured to apply an affine transformation followed by a second nonlinear activation function to the plurality of Boolean or multi-valued logic intermediate activations to generate a second plurality of output activations for each neural network layer in the second plurality of neural network layers.

In another aspect of the seventh embodiment, one or more neurons in one or more of the neural network layers are realized by using standard or custom logic cells in an application-specific integrated circuit, k-input look-up tables in a field programmable gate array device, or gate-level operation commands in a digital signal processor, a graphics processing unit, or a general purpose central processing unit.

In another aspect of the seventh embodiment, the circuit includes one or more integrated memory units, each memory unit configured to hold any or all input and output activations for each neural network layer.

In another aspect of the seventh embodiment, one or more neurons in any neural network layers are realized as a weighted linear combination of a number of logic sub-blocks, where each logic sub-block implements a subset of input-output logic functions of the said one or more neurons.

In another aspect of the seventh embodiment, one or more logic computation units execute Boolean or multi-valued logic operations corresponding to Boolean or multi-valued logic functions of a neural network layer in the second plurality of neural network layers, the Boolean or multi-valued logic functions describing logic behaviors of output signal lines carrying the output activations in terms of input signal lines carrying the input activations.

In another aspect of the seventh embodiment, the Boolean or multi-valued logic functions for a neural network layer in the second plurality of neural network layers are obtained by two-level and multi-level logic minimization tools.

In another aspect of the seventh embodiment, the number of input activations to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

In another aspect of the seventh embodiment, the one or more logic computation units additionally perform a maximum pooling operation to calculate the largest value in each patch of a map of output activations of any convolutional layers.

In another aspect of the seventh embodiment, at least one of the one or more logic computation units is configured to receive a plurality of Boolean or multi-valued logic input activations for a first neural network layer and directly generates a plurality of Boolean or multi-valued logic output activations for a second neural network layer, wherein there may exist zero, one, or more neural network layers between the first neural network layer and the second neural network layer.

In another aspect of the seventh embodiment, the first neural network layer, the second neural network layer, and all intervening layers between the first and the second layers belong to the second plurality of neural network layers.

In an eighth embodiment, a convolutional neural network processing system is provided. The system includes an array of logic processing elements, each logic processing element configured to generate a plurality of Boolean or multi-valued logic output values by applying Boolean or multi-valued logic operations on its Boolean or multi-valued logic input values.

In an aspect of the eighth embodiment, the logic processing elements can be custom fixed-function logic circuits in an application-specific integrated circuit, k-input look-up tables in a field programmable gate array device, or gate-level operation commands in a software-programmable logic processor, a graphics processing unit, or a general purpose central processing unit.

In another aspect of the eighth embodiment, the system includes one or more integrated memory units, each memory unit configured to hold any or all input and output values for each neural network layer.

In another aspect of the eighth embodiment, the the array of logic processing elements execute Boolean or multi-valued logic operations corresponding to Boolean or multi-valued logic functions of a neural network layer, the Boolean or multi-valued logic functions describing logic behaviors of output signal lines carrying the outputs of the neural network layer in terms of input signal lines carrying the inputs of the neural network layer.

In another aspect of the eighth embodiment, the the Boolean or multi-valued logic functions for a neural network layer are obtained by two-level and multi-level logic minimization tools.

In another aspect of the eighth embodiment, the if the Boolean or multi-valued logic functions for a neural network layer are Boolean, each of these functions has an offset size that is larger than its onset size.

In another aspect of the eighth embodiment, the the number of input signal lines for each neuron in a neural network layer is upper bounded by a pre-specified input count value for the neuron, where the pre-specified input count value is lower than the number of neurons in the preceding neural network layers that couple into the neural network layer.

In another aspect of the eighth embodiment, the the array of logic processing elements additionally perform a maximum pooling operation to calculate the largest value in each patch of a map of output values of any convolutional layers.

In another aspect of the eighth embodiment, the at least one of the logic processing elements is configured to receive a plurality of Boolean or multi-valued logic input values for a first neural network layer and directly generates a plurality of Boolean or multi-valued logic output values for a second neural network layer, wherein there may exist zero, one, or more neural network layers between the first neural network layer and the second neural network layer.

In another aspect of the eighth embodiment, the at least one of the logic processing elements is configured to produce a weighted linear combination of a number of logic sub-blocks, where each logic sub-block implements a sub-function of input-output logic functions for a neural network layer.

In a nineth embodiment, a neural network processing system is provided. The system includes an array of arithmetic processing elements, each processing element configured to perform addition, multiplication, pooling, batch normalization, and nonlinear transformation for a layer in a first plurality of neural network layers. The system also includes an array of logic processing elements, each logic processing element configured to perform Boolean or multi-valued logic operations for a layer in a second plurality of neural network layers. The system also includes one of more layers in the first plurality of neural network layers or the second plurality of neural network layers are of convolutional type.

In an aspect of the nineth embodiment, the system further includes one or more data transformation modules existing between the outputs of the array of arithmetic processing elements and the inputs of the array of logic processing elements and vice versa, each data transformation module configured to selectively apply a transformation between data representation domains of the two arrays of processing elements.

In another aspect of the nineth embodiment, the logic processing elements can be custom fixed-function logic circuits in an application-specific integrated circuit, k-input look-up tables in a field programmable gate array device, or gate-level operation commands in a software-programmable logic processor, a graphics processing unit, or a general purpose central processing unit.

In another aspect of the nineth embodiment, the system includes one or more integrated memory units, each memory unit configured to hold any or all input and output values for each neural network layer.

In another aspect of the nineth embodiment, the array of logic processing elements execute Boolean or multi-valued logic operations corresponding to Boolean or multi-valued logic functions of a neural network layer in the second plurality of neural network layers, the Boolean or multi-valued logic functions describing logic behaviors of output signal lines carrying the outputs of the layer in terms of input signal lines carrying the inputs of the layer.

In another aspect of the nineth embodiment, the Boolean or multi-valued logic functions for a neural network layer in the second plurality of neural network layers are obtained by two-level and multi-level logic minimization tools.

In another aspect of the nineth embodiment, if the Boolean or multi-valued logic functions for a neural network layer in the second plurality of neural network layers are Boolean, each of these functions has an offset size that is larger than its onset size.

In another aspect of the nineth embodiment, where the number of input values to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

In another aspect of the nineth embodiment, the array of logic processing elements additionally perform a maximum pooling operation to calculate the largest value in each patch of a map of output values of any convolutional layers.

In another aspect of the nineth embodiment, at least one of the logic processing elements is configured to receive a plurality of Boolean or multi-valued logic input values for a first neural network layer and directly generates a plurality of Boolean or multi-valued logic output values for a second neural network layer, wherein there may exist zero, one, or more neural network layers between the first neural network layer and the second neural network layer.

In another aspect of the nineth embodiment, the first neural network layer, the second neural network layer, and all intervening layers between the first neural network layer and the second neural network layer belong to the second plurality of neural network layers.

In another aspect of the nineth embodiment, at least one of the logic processing elements is configured to produce a weighted linear combination of a number of logic sub-blocks, where each logic sub-block implements a sub-function of input-output logic functions for a neural network layer.

In a tenth embodiment, a neural network processing circuit is provided. The circuts includes a first array of arithmetic processing elements, each processing element configured to perform addition, multiplication, pooling, batch normalization, and nonlinear transformation for a layer in a first plurality of neural network layers. The circuit also includes an array of logic processing elements, each logic processing element configured to perform Boolean or multi-valued logic operations for a layer in a second plurality of neural network layers. The circuit also includes a second array of arithmetic processing elements, each processing element configured to perform addition, multiplication, pooling, batch normalization, and nonlinear transformation on the outputs of the array of logic processing elements for each layer in the second plurality of neural network layers.

In an aspect of the tenth embodiment, at each processing element in the second array of arithmetic processing elements is configured to apply an identity transformation to the outputs of the array of logic processing elements for each neural network layer in the second plurality of neural network layers.

In another aspect of the tenth embodiment, at where the first plurality of neural network layers include one or more convolutional layers.

In another aspect of the tenth embodiment, the circuit futher includes one or more data transformation modules existing between the outputs of the array of arithmetic processing elements and the inputs of the array of logic processing elements and vice versa, each data transformation module configured to selectively apply a transformation between data representation domains of the two arrays of processing elements.

In another aspect of the tenth embodiment, the logic processing elements can be custom fixed-function logic circuits in an application-specific integrated circuit, k-input look-up tables in a field programmable gate array device, or gate-level operation commands in a software-programmable logic processor, a graphics processing unit, or a general purpose central processing unit.

In another aspect of the tenth embodiment, the circuit includes one or more integrated memory units, each memory unit configured to hold any or all input and output values for each neural network layer.

In another aspect of the tenth embodiment, the array of logic processing elements execute Boolean or multi-valued logic operations corresponding to Boolean or multi-valued logic functions of a neural network layer in the second plurality of neural network layers, the Boolean or multi-valued logic functions describing logic behaviors of output signal lines carrying the outputs of the layer in terms of input signal lines carrying the inputs of the layer.

In another aspect of the tenth embodiment, the Boolean or multi-valued logic functions for a neural network layer in the second plurality of neural network layers are obtained by two-level and multi-level logic minimization tools.

In another aspect of the tenth embodiment, the Boolean or multi-valued logic functions for a neural network layer in the second plurality of neural network layers are Boolean, each of these functions has an offset size that is larger than its onset size.

In another aspect of the tenth embodiment, the number of input values to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

In another aspect of the tenth embodiment, the array of logic processing elements additionally perform a maximum pooling operation to calculate the largest value in each patch of a map of output values of any convolutional layers.

In another aspect of the tenth embodiment, at least one of the logic processing elements is configured to receive a plurality of Boolean or multi-valued logic input values for a first neural network layer and directly generates a plurality of Boolean or multi-valued logic output values for a second neural network layer, wherein there may exist zero, one, or more neural network layers between the first neural network layer and the second neural network layer.

In another aspect of the tenth embodiment, the first neural network layer, the second neural network layer, and all intervening layers between the first neural network layer and the second neural network layer belong to the second plurality of neural network layers.

In another aspect of the tenth embodiment, at least one of the logic processing elements is configured to produce a weighted linear combination of a number of logic sub-blocks, where each logic sub-block implements a sub-function of input-output logic functions for a neural network layer.

In an eleventh embodiment, a neural network processing circuit is provided. The circuit include an array of arithmetic processing elements, each processing element configured to perform addition, multiplication, pooling, batch normalization, and nonlinear transformation for a layer in a first plurality of neural network layers. The circuit also includes an array of logic processing elements, each logic processing element configured to perform Boolean or multi-valued logic operations for a layer in a second plurality of neural network layers. The circuit also includes an array of data transformation modules to selectively convert data representation formats for the outputs of the array of arithmetic processing elements that feed directly into the inputs of the array of logic processing elements and vice versa.

In an aspect of the eleventh embodiment, the data transformation modules are configured to apply an identity transformation between the outputs of the array of arithmetic processing elements and the inputs of the array of logic processing elements and vice versa.

In another aspect of the eleventh embodiment, the first plurality of neural network layers include one or more convolutional layers.

In another aspect of the eleventh embodiment, the circuit includes a second array of arithmetic processing elements, each processing element configured to perform addition, multiplication, pooling, batch normalization, and nonlinear transformation on the outputs of the array of logic processing elements for each layer in the second plurality of neural network layers.

In another aspect of the eleventh embodiment, the logic processing elements can be custom fixed-function logic circuits in an application-specific integrated circuit, k-input look-up tables in a field programmable gate array device, or gate-level operation commands in a software-programmable logic processor, a graphics processing unit, or a general purpose central processing unit..

In another aspect of the eleventh embodiment, the circuit includes one or more integrated memory units, each memory unit configured to hold any or all input and output values for each neural network layer.

In another aspect of the eleventh embodiment, the array of logic processing elements execute Boolean or multi-valued logic operations corresponding to Boolean or multi-valued logic functions of a neural network layer in the second plurality of neural network layers, the Boolean or multi-valued logic functions describing logic behaviors of output signal lines carrying the outputs of the layer in terms of input signal lines carrying the inputs of the layer.

In another aspect of the eleventh embodiment, the Boolean or multi-valued logic functions for a neural network layer in the second plurality of neural network layers are obtained by two-level and multi-level logic minimization tools.

In another aspect of the eleventh embodiment, if the Boolean or multi-valued logic functions for a neural network layer in the second plurality of neural network layers are Boolean, each of these functions has an offset size that is larger than its onset size.

In another aspect of the eleventh embodiment, the number of input values to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

In another aspect of the eleventh embodiment, one or more logic computation units additionally perform a maximum pooling operation to calculate the largest value in each patch of a map of output values of any convolutional layers.

In another aspect of the eleventh embodiment, at least one of the logic processing elements is configured to receive a plurality of Boolean or multi-valued logic input values for a first neural network layer and directly generates a plurality of Boolean or multi-valued logic output values for a second neural network layer, wherein there may exist zero, one, or more neural network layers between the first neural network layer and the second neural network layer.

In another aspect of the eleventh embodiment, the first neural network layer, the second neural network layer, and all intervening layers between the first neural network layer and the second neural network layer belong to the second plurality of neural network layers.

In another aspect of the eleventh embodiment, at least one of the logic processing elements is configured to produce a weighted linear combination of a number of logic sub-blocks, where each logic sub-block implements a sub-function of input-output logic functions for a neural network layer.

In a twelfth embodiment, a method of optimizing a convolutional neural network is provided. The method includes a step of assigning neural network layers to a first plurality or a second plurality of neural network layers. The method also includes a step of producing output activations of a first plurality of neural network layers by performing arithmetic operations, including addition/subtraction and multiplication to do computations of sublayers within the first plurality of neural network layers, including any required linear or convolutional computations, pooling, batch normalization, and nonlinear transformation. The method also includes a step of producing Boolean or multi-valued output activations of the second plurality of neural network layers by performing Boolean or multi-valued logic operations on Boolean or multi-valued input activations of the second plurality of neural network layers.

In another aspect of the twelfth embodiment, an assignment of a neural network layer to the first plurality of neural network layers or the second plurality of neural network layers is done based on a sensitivity analysis of neural network output accuracy to the bit precision of the layer.

In an aspect of the twelfth embodiment, activation functions used for processing the first plurality of neural network layers and the second plurality of neural network layers are different.

In another aspect of the twelfth embodiment, the activation function used for processing the second plurality of neural network layers is a parameterized hard tangent hyperbolic function.

In another aspect of the twelfth embodiment, a Boolean or multi-valued function of each neuron in each layer of the second plurality of neural network layers is obtained by
a. constructing a many-to-one mapping that relates input activations to the output activation of a neuron; and
b. performing two-level and multi-level logic optimizations to achieve a low-cost representation of the many-to-one mapping.

In another aspect of the twelfth embodiment, the many-to-one mapping for each neuron is obtained by enumerating all or a subset of all possible input activations for the neuron.

In another aspect of the twelfth embodiment, the subset of all possible input activations is derived from a training data set for the neural network, is obtained based on a sampling of the training data set, or is generated synthetically from the training data set.

In another aspect of the twelfth embodiment, the many-to-one mapping for each neuron is a truth table whereby each entry in the truth table comprises input activations and an output activation, the input activations are values observed at the inputs of the neuron for each input patch and each data point in the full, sampled or synthetically-generated training data set and the output activation is produced by doing any required linear or convolutional computations, pooling, batch normalization, and nonlinear transformation on the input activations.

In another aspect of the twelfth embodiment, the truth table describes an incompletely-specified Boolean or multi-valued logic function, in which don’t cares correspond to input activations that are not encountered during the training phase of the neural network.

In another aspect of the twelfth embodiment, the two-level and multi-level logic optimizations are done in such a way that the Boolean or multi-valued logic function of each neuron is only approximately equal to the truth table representation of the neuron.

In another aspect of the twelfth embodiment, the sampling method favors sample selection around the mean value or support vector machine values of the training data set.

In another aspect of the twelfth embodiment, the synthetic method generates new training data based on Data Shapley values of data in the training data set.

In a thirteenth embodiment, a method of optimizing a neural network is provided. The method includes a step of assigning neural network layers to a first plurality or a second plurality of neural network layers. The method also includes a step of producing output activations for the first plurality of neural network layers by performing arithmetic operations including addition, multiplication, pooling, batch normalization, and nonlinear transformation operations. The method also includes a step of producing output activations for the second plurality of neural network layers by performing Boolean or multi-valued logic operations on Boolean or multi-valued input activations of the second plurality of neural network layers to produce Boolean or multi-valued intermediate activations followed by additional arithmetic operations involving the intermediate activations to do the required computations of additional sublayers within the second plurality of neural network layers including linear and nonlinear transformation sublayers.

In an aspect of the thirteenth embodiment, an assignment of a neural network layer to the first plurality of neural network layers or the second plurality of neural network layers is done based on a sensitivity analysis of neural network output accuracy to the bit precision of the layer.

In another aspect of the thirteenth embodiment, the activation functions used for processing the first plurality of neural network layers and the second plurality of neural network layers are different.

In another aspect of the thirteenth embodiment, the activation function used for processing the second plurality of neural network layers is a parameterized hard tangent hyperbolic function.

In another aspect of the thirteenth embodiment, a Boolean or multi-valued function of each neuron in each layer of the second plurality of neural network layers is obtained by
a. constructing a many-to-one mapping which relates input activations to the output activation of a neuron; and
b. performing two-level and multi-level logic optimizations to achieve a low-cost representation of the many-to-one mapping.

In another aspect of the thirteenth embodiment, the many-to-one mapping for each neuron is obtained by enumerating all or a subset of all possible input activations for the neuron.

In another aspect of the thirteenth embodiment, the subset of all possible input activations is derived from a training data set for the neural network, is obtained based on a sampling of the training data set, or is generated synthetically from the training data set.

In another aspect of the thirteenth embodiment, the many-to-one mapping for each neuron is a truth table whereby each entry in the truth table comprises input activations and an output activation, the input activations are values observed at the inputs of the neuron for each input patch and each data point in the full, sampled or synthetically-generated training data set and the output activation is produced by doing any required linear or convolutional computations, pooling, batch normalization, and nonlinear transformation on the input activations.

In another aspect of the thirteenth embodiment, the truth table describes an incompletely-specified Boolean or multi-valued logic function, in which don’t cares correspond to input activations that are not encountered during the training phase of the neural network.

In another aspect of the thirteenth embodiment, the two-level and multi-level logic optimizations are done in such a way that the Boolean or multi-valued logic function of each neuron is only approximately equal to the truth table representation of the neuron.

In another aspect of the thirteenth embodiment, the sampling method favors sample selection around the mean value or support vector machine values of the training data set.

In another aspect of the thirteenth embodiment, the synthetic method generates new training data based on Data Shapley values of data in the training data set.

In a fourteenth embodiment, a method of optimizing a neural network is provided. The method includes a step of assigning neural network layers to a first plurality or a second plurality of neural network layers. The method also includes a step of producing output activations of the first plurality of neural network layers by performing arithmetic operations, including addition/subtraction and multiplication to do computations of sublayers within the first plurality of neural network layers, including any required linear or convolutional computations, pooling, batch normalization, and nonlinear transformation. The method also includes a step of producing Boolean or multi-valued output activations of the second plurality of neural network layers by performing Boolean or multi-valued logic operations on Boolean or multi-valued input activations of the second plurality of neural network layers. The method also includes a step of selectively converting data representation formats for the output activations of a group of neural network layers that feed directly into a first neural network layer to a required data representation format for the input activations of the first neural network layer.

In an aspect of the fourteenth embodiment, an assignment of a neural network layer to the first plurality of neural network layers or the second plurality of neural network layers is done based on a sensitivity analysis of neural network output accuracy to the bit precision of the layer.

In another aspect of the fourteenth embodiment, the activation functions used for processing the first plurality of neural network layers and the second plurality of neural network layers are different.

In another aspect of the fourteenth embodiment, the activation function used for processing the second plurality of neural network layers is a parameterized hard tangent hyperbolic function.

In another aspect of the fourteenth embodiment, a Boolean or multi-valued function of each neuron in each layer of the second plurality of neural network layers is obtained by
a. constructing a many-to-one mapping which relates input activations to the output activation of a neuron; and
b. performing two-level and multi-level logic optimizations to achieve a low-cost representation of the many-to-one mapping.

In another aspect of the fourteenth embodiment, the many-to-one mapping for each neuron is obtained by enumerating all or a subset of all possible input activations for the neuron.

In another aspect of the fourteenth embodiment, the subset of all possible input activations is derived from a training data set for the neural network, is obtained based on a sampling of the training data set, or is generated synthetically from the training data set.

In another aspect of the fourteenth embodiment, the many-to-one mapping for each neuron is a truth table whereby each entry in the truth table comprises input activations and an output activation, the input activations are values observed at the inputs of the neuron for each input patch and each data point in the full, sampled or synthetically-generated training data set and the output activation is produced by doing any required linear or convolutional computations, pooling, batch normalization, and nonlinear transformation on the input activations.

In another aspect of the fourteenth embodiment, the truth table describes an incompletely-specified Boolean or multi-valued logic function, in which don’t cares correspond to input activations that are not encountered during the training phase of the neural network.

In another aspect of the fourteenth embodiment, the two-level and multi-level logic optimizations are done in such a way that the Boolean or multi-valued logic function of each neuron is only approximately equal to the truth table representation of the neuron.

In another aspect of the fourteenth embodiment, the sampling method favors sample selection around the mean value or support vector machine values of the training data set.

In another aspect of the fourteenth embodiment, the synthetic method generates new training data based on Data Shapley values of data in the training data set.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. an exemplary neural network accelerator architecture, according to embodiments of the disclosure;

FIG. 2. High-level Overview of the Neural Network Processing System;

FIG. 3. An example of a multilayer perceptron;

FIG. 4. An example of a convolutional neural network;

FIG. 5. An example of the generally used design for neural network inference task;

FIG. 6. An example of the generally used design for XNOR and pop count operations for neural network inference task when having binary representation for weights and activations;

FIG. 7. Boolean processor;

FIG. 8. An example of logic processing element;

FIG. 9 An example of crossbar architecture (for connecting 16 LPM to 16 LPM) consists of several 4 × 4 crossbar.;

FIG. 10. An example of a DNN mapped to the HyFEN fabric;

FIG. 11. AND gate realization through neural network;

FIG. 12. The flow of neural network realization through truth table generation;

FIG. 13. An example of a neuron model;

FIG. 14. Efficient realization of the exemplary neuron using logic gates;

FIG. 15 An example of a multi-valued function;

FIG. 16. An example of a boolean (single-valued) function;

FIG. 17. An example of vestigial layer;

FIG. 18. An example of matrix computation unit;

FIG. 19. An example of a voting layer;

FIG. 20. An example of Neural Network Processing Circuit;

FIG. 21. An example of Neural Network Processing Circuit;

FIG. 22. An example of Neural Network Processing Circuit;

FIG. 23. An example of Neural Network Processing Circuit;

FIG. 24. An example of Convolutional Neural Network Inference System;

FIG. 25. An example of Convolutional Neural Network Inference System;

FIG. 26. An example of Convolutional Neural Network Inference System;

FIG. 27. An example of Convolutional Neural Network Inference System;

FIG. 28. HyFEN compiler workflow;

FIG. 29. The training module in HyFEN compiler workflow, comprisingquantization-aware training and fanin-constrained pruning.;

FIG. 30. The logic minimization module in HyFEN compiler workflow, comprising the two-level logic minimization and the multi-level logic minimization.;

FIG. 31. The back-end compilation module in HyFEN compiler workflow, performing optimizations tailored to the employed accelerator design realizing FFCLblocks for the implementation of the inference graph; and

FIG. 32. The SDAccel code generation module in HyFEN compiler workflow, comprising software and hardware code generation modules.

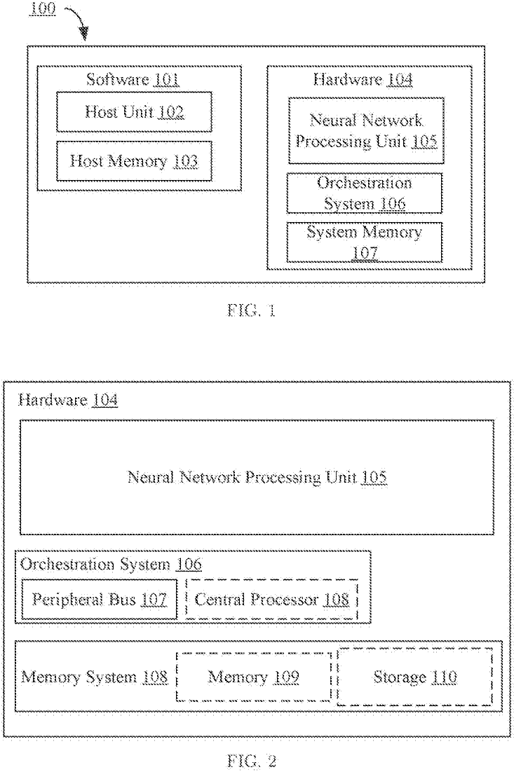

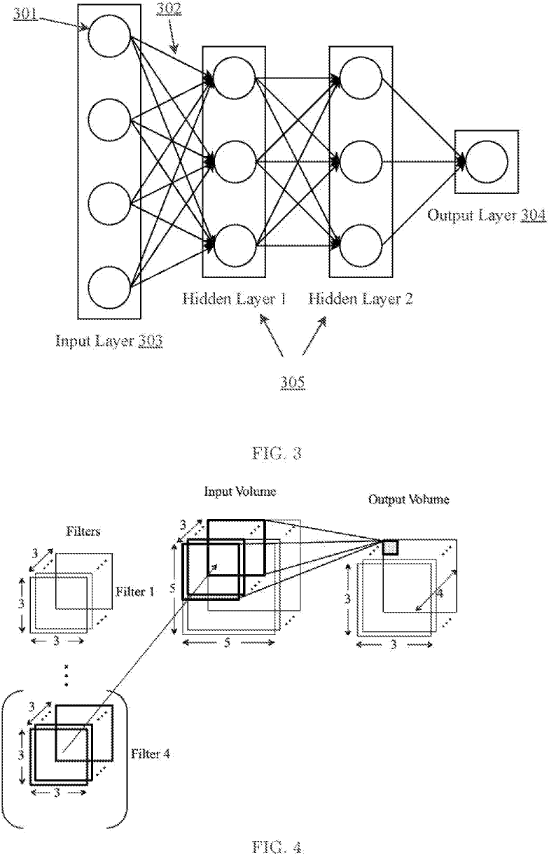

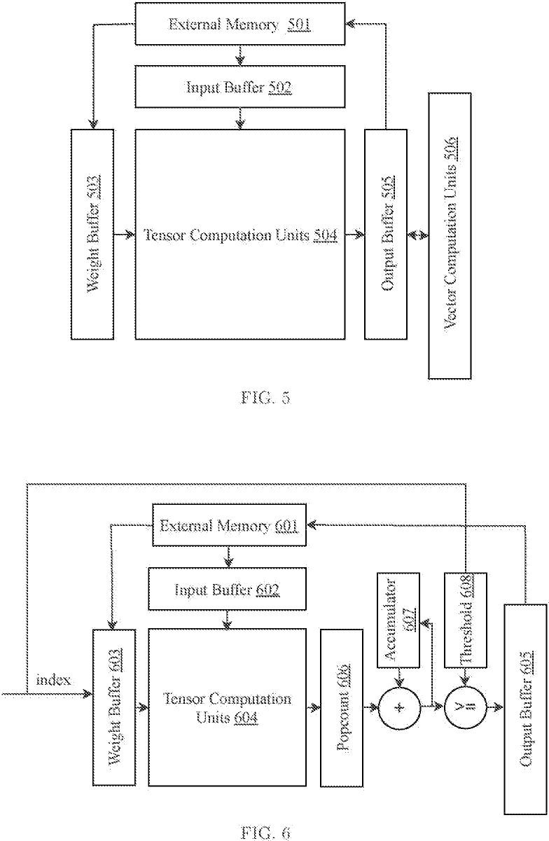

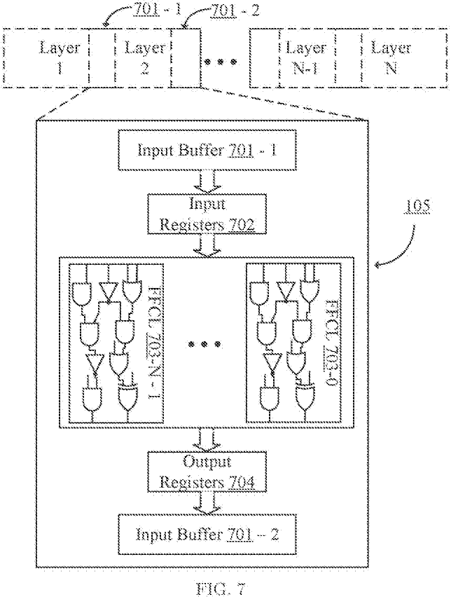

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4.... 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to a receiving electrical device. Indirect electrical communication can involve processing of the electrical signal, including but not limited to, filtering of the signal, amplification of the signal, rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ± 0%, 0.1%, 0.5%, 1%, 2%, 3%, 4%, 5% or 10% of the value or relative characteristic.

The term “electrical signal” refers to the electrical output from an electronic device or the electrical input to an electronic device. The electrical signal is characterized by voltage and/or current. The electrical signal can be stationary with respect to time (e.g., a DC signal) or it can vary with respect to time.

The terms “DC signal” refer to electrical signals that do not materially vary with time over a predefined time interval. In this regard, the signal is DC over the predefined interval. “DC signal” includes DC outputs from electrical devices and DC inputs to devices.

The terms “AC signal” refer to electrical signals that vary with time over the predefined time interval set forth above for the DC signal. In this regard, the signal is AC over the predefined interval. “AC signal” includes AC outputs from electrical devices and AC inputs to devices.

It should also be appreciated that any given signal that has a non-zero average value for voltage or current includes a DC signal (that may have been or is combined with an AC signal). Therefore, for such a signal, the term “DC” refers to the component not varying with time and the term “AC” refers to the time-varying component. Appropriate filtering can be used to recover the AC signal or the DC signal.

The term “electronic component” refers is any physical entity in an electronic device or system used to affect electron states, electron flow, or the electric fields associated with the electrons. Examples of electronic components include, but are not limited to, capacitors, inductors, resistors, thyristors, diodes, transistors, etc. Electronic components can be passive or active.

The term “electronic device” or “system” refers to a physical entity formed from one or more electronic components to perform a predetermined function on an electrical signal.

It should be appreciated that in any figures for electronic devices, a series of electronic components connected by lines (e.g., wires) indicates that such electronic components are in electrical communication with each other. Moreover, when lines directed connect one electronic component to another, these electronic components can be connected to each other as defined above.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

Throughout this application, where publications are referenced, the disclosures of these publications in their entireties are hereby incorporated by reference into this application to more fully describe the state of the art to which this invention pertains.

In general, the present invention provides a design for a new circuit architecture and the corresponding hardware/software system that greatly increase the efficiency (in terms of the latency, batch processing rate, and power consumption) of doing training and inference on neural networks, including both general deep neural networks (DNNs) as well as convolutional neural networks (CNNs), while satisfying a target output accuracy level for the neural network model.

More precisely, the HyFEN fabric comprises (i) conventional arithmetic processing part for doing the required operations for MAC-based layers, including a 2-D array of fixed-precision APEs to do the required tensor or matrix computations, and a 1-D array of special-purpose processors to further accumulate results coming out of the 2-D array and apply a nonlinear transformation to these accumulated results, (ii) buffer memories to store values for conventional MAC-based layers, including an on-chip weight buffer, and on-chip input activation buffer, and an on-chip output activation buffer, (iii) logic processing part for doing the required operations for the FFCL layers, including either custom hardware or a 2-D array of LPEs, optionally followed by a 1-D array of special-purpose processors to apply a linear transformation to the outputs of these logic processors, (iv) an embedded micro-controller to control the timing and addressing of data transfers from off-chip memory system to these on-chip buffers and vice versa. The controller additionally orchestrates (assigns and schedules) arithmetic operations on hardware and performs load and store of data from/to buffers, and (v) supporting on-chip busses, I/O interfaces, and a SDRAM DDRx controller.

As stated above, the HyFEN fabric deals with DNNs/CNNs that include FFCL layers. These FFCL layers involve many Boolean and/or multi-valued logic operations needed to produce output functions of the neurons/filters. These operations can be realized as a customized hard network of logic gates (as in random logic blocks of an application specific integrated circuit) or by using programmable logic processors that can perform the required logic gate operations of any logic (computation) graphs. The former realization is ideal for building a highly efficient, yet unchangeable, inference engine whereas the latter realization is desirable for accelerating the training process and for building inference engines that have to be updated after they are deployed in the field.

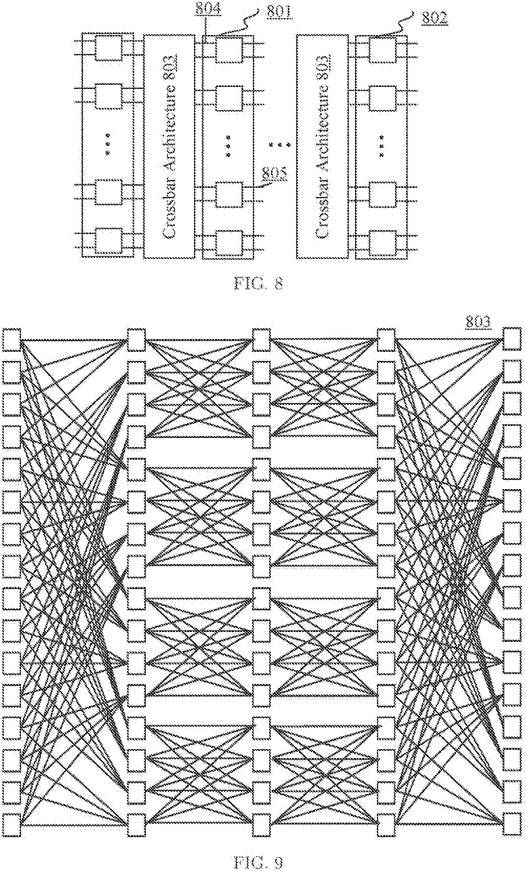

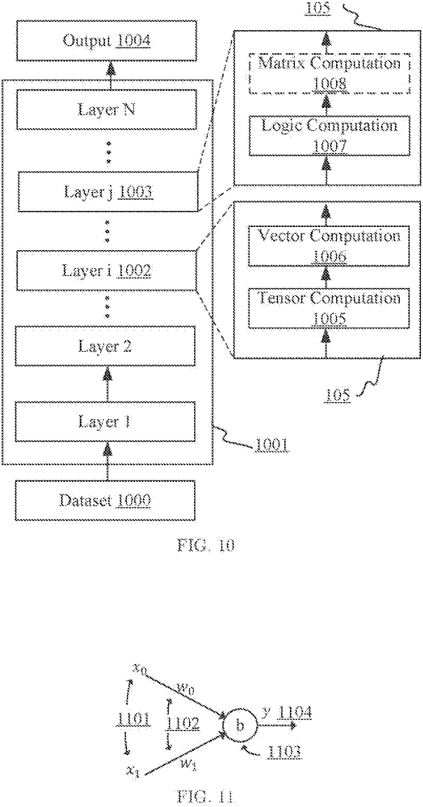

An exemplary implementation of the LPE is now described with reference to FIG. 8. While specific configurations and arrangements are discussed, it should be understood that this is performed for illustrative purposes only. The architecture of the LPE shown is a data-driven one in the sense that the streaming data is received and processed by multiple stages of computational logic element without having to store any intermediate results in some scratchpad memory. More precisely, a LPE comprises a set of logic processing vectors (LPVs) 801 that are linearly ordered. Each LPV contains 32 logic processing macros (LPMs) 802, each of which receives two inputs and produces two outputs. The LPM performs any of the following logic operations: AND2/NAND2, OR2/NOR2, XOR2/XNOR2, BUFFER/BUFFER, INVERTBUFFER, etc. where X/Y refer to the first and second output functions of the LPM, respectively. Therefore, each LPV received a vector of 64 input operands 804 and produces a vector of 64 output results 805. To support logic operation packing and increase hardware efficiency, each operand has a width of 64 bits, which translates into 64 Boolean variables or 32 4-valued logic variables, etc. The 64 bits of data come from different patches of an input feature volume in a CNN or from different batch-mode inference tasks (e.g., images in computer vision) in a DNN. The 64 outputs of the ith LPV are fed to the 64 inputs of the (i+1)st LPV using a multi-stage (e.g., five-stage) crossbar architecture 803 as is well known to a person skilled in the art. The number of LPVs in the LPE is set to 16. The computation latency from input to output of the LPE is therefore 16*6=96 cycles, where 16 is the number of LPVs, 1 cycle is to do the logic computation in the LPM and 5 cycles are needed to go through the crossbar structures between the LPVs.

The number of LPMs per LPV and the number of LPVs per LPE determine the size of the logic graph that can be processed by any LPE. With the parameter values described previously, a LPE can process a logic graph with maximum width of 32 and maximum depth of 16, where the maximum width refers to the maximum number of logic operations at any logic depth in the graph and the maximum depth refers to the maximum logic depth from any graph inputs to any graph outputs. For larger graphs multiple LPEs can be assembled in parallel or serial configuration to complete the required computations in the given logic graph. For example, if the maximum width and depth of a given logic graph are 53 and 26 respectively, then one can parallel connect a pair of LPEs which are then serially connected to another pair of parallel-connected LPEs to complete all operations in the given logic graph.

Equipped with the LPE array, the HyFEN fabric may be used to accelerate the training process of DNNs/CNNs. More precisely, the LPE array is used to perform the forward computations of a mini batch during the training process and is subsequently reprogrammed as a result of the back propagation step. The process is repeated across many mini batches and many training epoch until the network is fully trained as is known by a person skilled in the art, which means that all weights for MAC layers are determined and all neuron/filter functions for the FFCL layers are chosen.

The HyFEN compiler divides the neural network layers into at least two types: conventional MAC-based layers and custom FFCL layers, which do not require any weight look-ups and instead rely on very low cost Boolean or multi-valued logic operations. Optionally some layers may be classified as XOR-based or other types of layers. FIG. 10 illustrates an example of the HyFEN fabric where layer i 1002 is a MAC-based layer and layer j 1003 is an FFCL layer. The combination of the HyFEN fabric and HyFEN compiler thus produces an across-the-stack solution for energy-efficient, low-latency processing of DNNs.

Provisions are also provided to enhance the output quality of the neural network inference by selectively passing the output activations coming of the logic processing elements through conventional processing elements that generate a weighted linear combination of these activations followed by application of some nonlinear transformation to the said combination (such selections can be done through pruning). Data transformation modules are also provided to allow seamless transfer of data from one layer type to another, if such transfer required a change in the bit-width or data representation format of the data.

### General Description of the Invention

Given a neuron and its (weighted) input connections, this invention enumerates all or some of the input combinations for the neuron, constructs the logic function of the neuron, and implements this logic function as a series of simple logic operations and eventually logic gates. In this way it avoids complex arithmetic operations such as multiplications and additions as well as weight memory look-ups.

In the HyFEN framework, a neuron’s output may be produced by performing arithmetic operations or by doing Boolean/multi-valued logic operations. Multi-valued logic refers to having more than one bit of information for each of inputs/outputs of the logic function and can take on values P = {0,1,..., |P| - 1} (integers - but no ordering implied). An example of multi-valued function of 2 variables with a value P = 3 is shown in FIG. 15. This multi-valued function can be written in the form of a sum of cubes for each of its values, such as:

$$\begin{matrix}{F}^{\left\{0\right\}} = {X}_{1}^{\left\{0\right\}} {X}_{2}^{\left\{0\right\}} \\ {F}^{\left\{1\right\}} = {X}_{1}^{\left\{2\right\}} {X}_{2}^{\left\{0 , 1\right\}} + {X}_{1}^{\left\{0\right\}} {X}_{2}^{\left\{1\right\}} \\ {F}^{\left\{2\right\}} = {X}_{1}^{\left\{1\right\}} + {X}_{1}^{\left\{0 , 2\right\}} {X}_{2}^{\left\{2\right\}}\end{matrix} \qquad \text{(4)}$$

where each

$${X}_{i}^{{c}_{i}}$$

is a multi-valued literal and a logic function in the form:

$${X}_{i}^{{c}_{i}} = \left({X}_{i} = γ {}_{1}\right) + ⋯ + \left({X}_{i} = {γ}_{k}\right) , \text{where} {γ}_{j} ∈ {c}_{i} ⊆ {P}_{i} \qquad \text{(5)}$$

For example,

$${X}_{i}^{\left\{0 , 2\right\}}$$

denotes a multi-valued literal which has a value of 1 when XL is either 0 or 2. Obviously,

$${X}_{i}^{\left\{0 , 2\right\}} + {X}_{i}^{\left\{1\right\}} = 1 \left(\text{tautology}\right)$$

with P = 3. This is analogous to two-valued (binary) case where

$$\begin{matrix}{X}_{i}^{\left\{0\right\}} = {\overline{X}}_{i} \\ {X}_{i}^{\left\{1\right\}} = {X}_{i} \\ {X}_{i}^{\left\{0 , 1\right\}} = 1 \left(\text{tautology}\right)\end{matrix} \qquad \text{(6)}$$

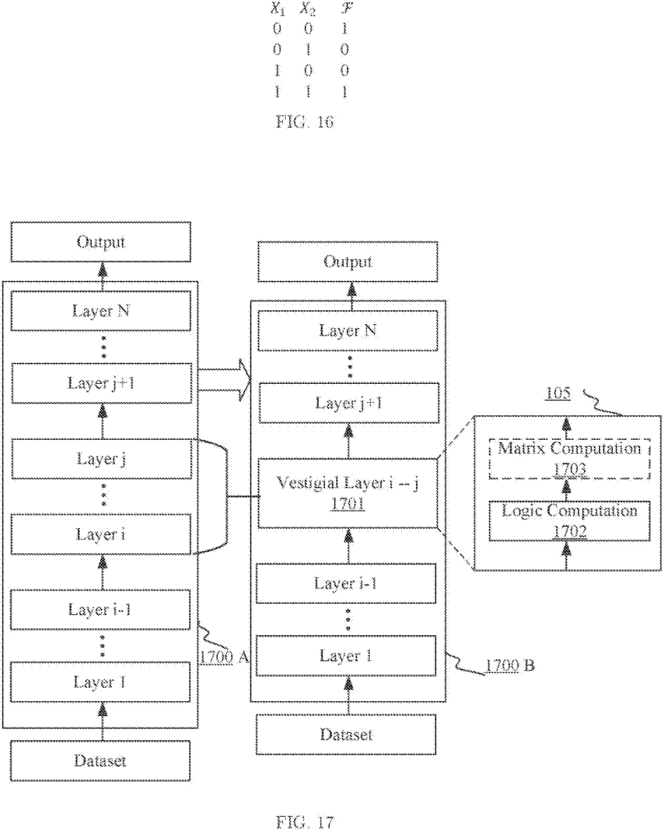

and we can write the binary function of two variables shown in FIG. 16 as

$$\begin{matrix}F = {X}_{1}^{\left\{0\right\}} {X}_{2}^{\left\{0\right\}} + {X}_{1}^{\left\{1\right\}} {X}_{2}^{\left\{1\right\}} \\ = {\overline{X}}_{1} {\overline{X}}_{2} + {X}_{1} {X}_{2}\end{matrix} \qquad \text{(7)}$$

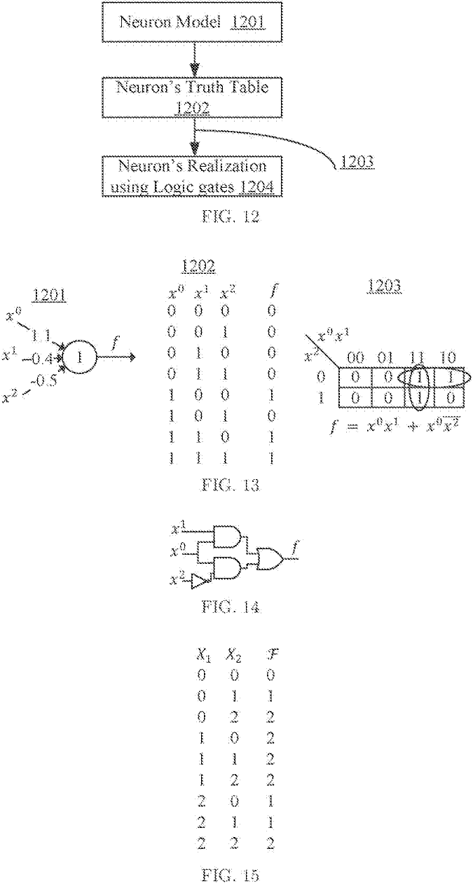

One method to derive the logic function of each neuron in a DNN/CNN is depicted in FIG. 12. The assumed neuron model 1201 is shown in FIG. 13. In this method, all different combinations of a neuron’s inputs are enumerated and the corresponding outputs are found according to the neuron’s weights and bias (Eq. 1). This is in fact equivalent to finding a truth table 1202 for each neuron as shown in FIG. 13 for this example. The truth table implements the exact same function as the neuron’s function when its output is calculated using Eq. 1.

Given a neuron’s truth table, one can write the function of each neuron as a sum of minterms representation, which is captured by a Karnaugh map representation 1203 as shown in FIG. 13. The sum of minterms representation for each neuron can then be fed to a logic synthesis tool, which optimizes the representation by first generating a minimum-cost sum of products (SOP) and then constructing a multi-level logic network where nodes of the network have simple logic functions. This network can then be mapped to a library of logic gates including NOT, AND/NAND, OR/NOR, XOR/XNOR, etc. The resulting realiazation is called a mapped logic network or MLN for short. In other words, instead of realizing the output of a neuron by calculating the dot product of its inputs and weights, we implement the output using logic gates by synthesizing its logic expression. FIG. 14 provides an example of such a realization. The advantage is that the function represented by an MLN considers the neuron’s parameters implicitly and allows inference without having to read model parameters from memory.

Another method to construct the logic specification for neurons is to apply all or a subset of the training data points to the neural network, and for each neuron, record the binary (or multi-valued logic) values of the neuron’s inputs and outputs and subsequently construct an incompletely specified function (ISF) for the neuron. This ISF is a Boolean (or multi-valued logic) function where output values are defined only for a subset of input combinations. The input combinations that cause a logic one at the output constitute the on-set and the input combinations that cause a logic zero at the output constitute the off-set of the ISF. The input combinations for which the output value is not specified make up the don’t care-set (or dc-set for short) for the ISF. In this method, instead of enumerating all input combinations for each neuron, we only evaluate outputs of neurons for input combinations derived from samples in the training set and add the remaining input combinations to the dc-set of the neuron. As a result, the cardinality of on-set and off-set will be linear functions of the cardinality of the training set (or chosen subset of the training set), rather than an exponential function of the number of inputs of the neuron, which is the case for the full enumeration method.

Realizing DNNs based on ISFs has a few advantages. Similar to the method explained earlier, this technique allows inference without storing model parameters explicitly. In other words, the logic gate realization of each ISF considers the neuron’s parameters implicitly and does not require memory accesses for reading the neuron’s weights and bias. This results in substantial savings in latency and energy consumption. Furthermore, the presence of the dc-set allows optimizing logic to a greater extent, which translates into considerably lower hardware resource usage and substantially lower latency compared to using MACs. Moreover, realization based on ISFs samples the algebraic function that represents each neuron and transforms that algebraic function into a Boolean (or multi-valued logic) function that approximates it. This approach is thus suitable for implementing neurons designed for real-world neural networks, which tend to include hundreds to thousands of inputs. For such neurons, the input space is huge and the samples only represent a tiny fraction of the input space that matters to the DNN, hence the approximation.

Logic realization based on the exhaustive input enumeration is suitable for neurons/filters with a small number of inputs while logic realization based on ISFs is more suitable for neurons with a large number of inputs. Notice that it is neither necessary nor feasible in many cases to apply all training data points to a DNN/CNN to derive the ISFs for neurons. For example, consider a convolutional layer in a CNN designed for the CIFAR-10 dataset with 50,000 data points. In the context of a CNN, one can think of a neuron as a 3-D filter which operates on a 3-D input feature volume to produce a 2-D output feature map. The convolutional layer may have many filters (corresponding to the number of output channels), thereby producing a 3-D output volume with each 2-D plane of this volume being produced by one of the said filters. Now consider one such filter. Suppose the input feature maps have a width of 32, a height of 32, and a depth of 128 (corresponding to 128 input channels) whereas the filter operates on different 3 × 3 × 128 3-D patches of the input feature map (with a padding of one on each side and a stride of one). This means that the logic function of this filter has a variable support of cardinality 3 × 3 × 128 = 1152. Moreover, the input feature maps give rise to 32 × 32 3-D patches for each applied training data point, and thus a total of 32 × 32 × 50,000 = 51.2 million minterms. Obviously, 51.2 million minterm count is exponentially smaller than the number of all possible input combinations of this filter (which is 2¹¹⁵² in case of the Boolean function realization and k¹¹⁵² in case of the k-valued logic function realization of the filter). Unfortunately, in spite of the huge reduction in the number of considered minterms for the filter compared to the enumeration-based approach, no logic synthesis tool can deal with optimizing a logic expression with so many minterms. Optimizing such an ISF with existing two-level logic minimization tools (e.g., ESPRESSO-II) is impossible as these tools can optimize functions with at most 50,000 or so minterms. Additionally, not all training points are informative from a logic minimization perspective and choosing a subset of the training points (training dataset sampling) tends to result in defining much simpler ISFs without sacrificing the classification accuracy.

This invention thus discloses three sampling approaches which rely on the trained model to find representative samples from the full training data. These approaches are similar in that they first apply the training data to the DNN/CNN and compute the output of each neuron/filter in each of the layers for each sample in the training data. Next they examine the outputs of a specific intermediate layer (typically this layer is the last feature extraction layer in a DNN/CNN) to rank the training data points (higher ranked training data points will be selected and used to generate the logic functions of all neurons in all FFCL layers of the target neural network). These approaches are different in the way that the intermediate layer information is used to rank the training data points.

The first approach, which we refer to as the support vector machine (SVM)-based sampling, uses the intermediate layer information of the training data in addition to the output class (label) information of the neural network to train a one-vs-rest SVM for each output class. Next, for each trained SVM corresponding to a class, this approach picks all support vectors as representative samples of the training dataset for that class. By aggregating the support vectors found by trained SVMs for all output classes, a subset of the training data is generated as a representative sample of the training dataset. When the total number of support vectors exceeds a target number of samples (which acts as an upper bound on the number of selected data points from the training dataset), a subset of support vectors is sampled.

The second approach, which we refer to as near-mean sampling, first finds a representative vector for each class by averaging the intermediate representation of all data points in the training data set that belong to that class. Next, for each class, it picks a training data point as a sample such that the difference between the average of the selected samples so far and the representative vector of the class is minimized. This step is repeated until the desired number of selected data points for each class is generated. The near-mean sampling, as its name suggests, picks samples close to the mean of intermediate representation of all samples which belong to a class. By combining the SVM-based sampling with the near-mean sampling, we have devised a third sampling approach, which finds samples of the training dataset that not only represent the boundaries but also the mean of each output class. This approach is generally superior to the other two sampling approaches and is the one that is typically adopted in the HyFEN framework.

This invention also discloses a technique for optimizing neurons with a large number of minterms in their specification. This technique creates multiple FFCLs corresponding to a neuron by picking a subset of training data for forming each FFCL where the subset can be either based on output labels or not. The outputs of FFCLs are then combined using a nonlinear transformation to produce a single output for the neuron. Examples of such transformations are a majority voter function and a fully-connected layer followed by an activation function.

Method 1 shows the general flow for optimizing the realization of a trained DNN/CNN. In this flow we have assumed that all layers except for the first and the last layers are FFCL layers. Furthermore, it is assumed that the selected sample of the full training data is applied to the trained network as a single batch and activations at different layers are found and provided as inputs to the algorithm. The next few paragraphs explain the details of each step of the algorithm.

Method 1 Optimization of DNNs/CNNs comprising FFCL layers except the first and last layers.

Input L: number of layers;
uᵢ, i = 0,1, 2,..., L: number of neurons in layer i:
imap: input feature map of all neurons in all layers (for all training samples)
omap: output feature of all neurons in all layers (for all training samples)
Output network
1: network= {}
2: for i = 2 to L - 1 do
3: lᵢ = {}
4: for j = () to uᵢ - 1 do
5: lᵢ= lᵢ U OptimizeNeuron(imap(i,j), omap(i,j))
6: end for
7: network = network U Optimize Layer(lᵢ)
8: end for
9: return network

OptimizeNeuron(. ) is a function that takes the ISF representation of each neuron and finds a minimal representation in disjunctive normal form for covering the neuron’s on-set. The objective of this step of the optimization is to take advantage of dc-set in finding a cover of the on-set that has the fewest possible number of cubes (i.e. conjunctive clauses) and fewest possible number of literals in the SOP representation. Notice that because the output of an ISF for dc-set is not specified, it can take either the logic zero or logic one during optimization. Typically, the elements of dc-set that are close to elements of on-set in the n-dimensional input space are assigned a value of one and the ones that are close to elements of off-set are assigned a value of zero. This is particularly useful in realization of DNNs because input combinations that are not encountered during application of the training data to the network will have the same output as the ones that have previously been encountered and are close to them (“closeness” in the context can be measured by the Hamming distance between the said elements).

OptimizeLayer() is the next optimization step which applies multi-level logic synthesis to all neurons that constitute a layer in order to generate the MLN realization of all neurons in the layer. Because different neurons of a layer share the same inputs, logic synthesis techniques such are generally able to extract common logic expressions that are used in different neurons. This in turn results in implementing the shared logic only once instead of implementing the logic separately for each neuron.

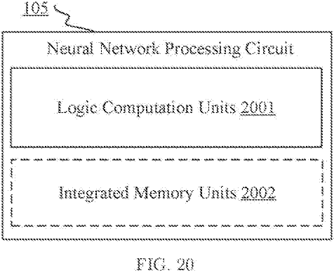

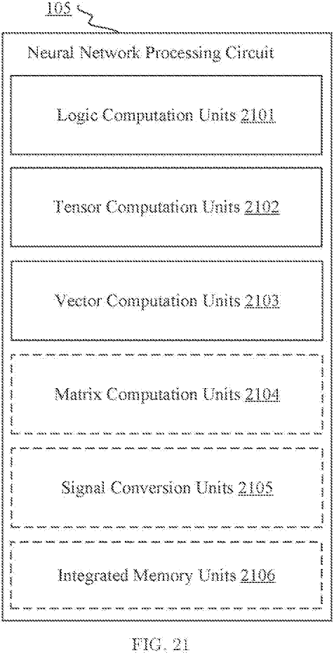

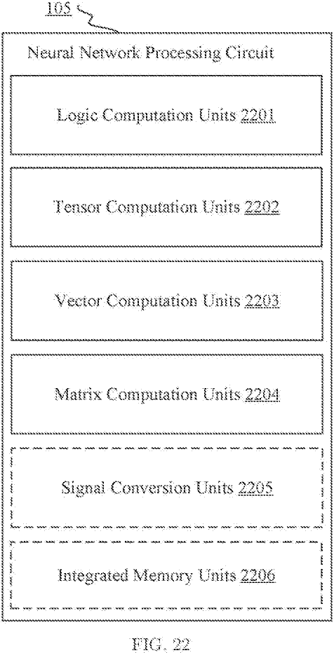

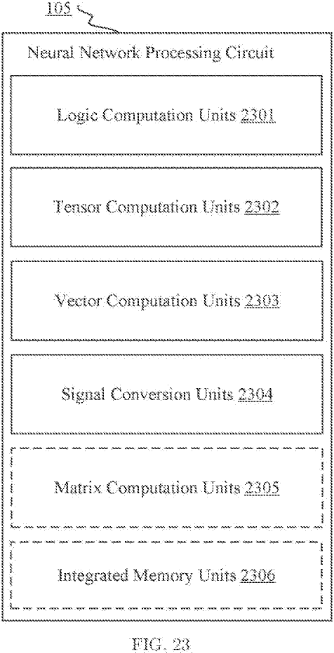

In an embodiment, a circuit for performing computations in a CNN is provided. The circuit comprises one or more logic computation units, each logic computation unit is configured to receive Boolean or multi-valued logic input activations for each neuron in a neural network layer and generate a Boolean or multi-valued logic output activation for the neuron by applying Boolean or multi-valued logic operations on the input activations for the neuron. The arrangement in FIG. 20 shows the block diagram of an exemplary design of a Neural Network Processing Circuit 105 for this case, comprising Logic Computation Units 2001.

In this circuit, the function of a neuron (also called a filter in the context of CNNs) is represented by a fixed-function combinational logic (FFCL) function. This function, which is derived during the network training process, performs a many-to-one mapping of input activation values to output activation values. The input and output activations for a layer may be Boolean (0 or 1) or multi-valued (e.g., 0, 1, 2, 3). Such a function is in turn realized by using standard or custom fixed-function logic circuits in an application-specific integrated circuit, k-input look-up tables in a field programmable gate array device, or gate-level logic operations executed in a software-programmable logic processor (a custom-made logic processing element), a digital signal processor, a graphics processing unit, or a general purpose central processing unit. The circuit may include one or more integrated memory units, each memory unit configured to hold any or all input and output activations for each neural network layer.

In this circuit, a logic computation unit executes Boolean or multi-valued logic operations corresponding to the Boolean or multi-valued logic function of the neuron. The circuit admits unstructured activation signal (connection edge) and neuron (filter) pruning using CNN pruning methods. More importantly, however, it employs a novel structured pruning technique in which the number of input activations to each neuron in a neural network layer is upper bounded by a pre-specified input count value for the neuron, where the value is lower than the number of neurons in the preceding neural network layers that couple into the neuron.

To reduce the size of the output feature map before passing it as input to the next convolutional layer, the logic computation unit may additionally perform a maximum pooling operation to calculate the largest value in each patch of a map of output activations of any neuron in any convolutional layers. Furthermore, at least one of the logic computation units may be configured to receive Boolean or multi-valued logic input activations for a first neural network layer and directly generate a plurality of Boolean or multi-valued logic output activations for a second neural network layer. Consequently, the first layer, the second layer, and all intervening layers are fused into a super-layer called a “vestigial layer”. FIG. 17 illustrates an example of a vestigial layer 1701 in neural network 1700B, which is constructed by combining consecutive layers i through j of neural network 1700A and subsequently using logic computation units 1702 and matrix computation units 1703 to implement this vestigial layer in hardware.

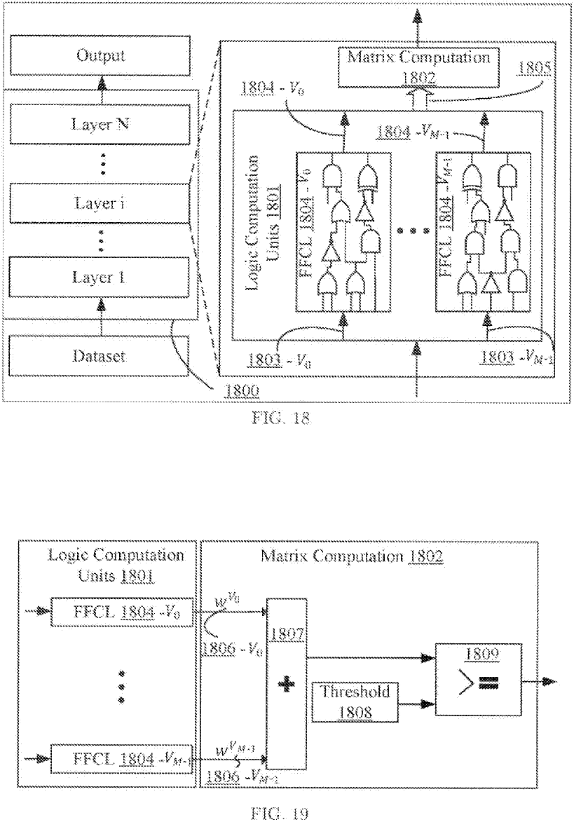

FIG. 18 shows an example of matrix computation units 1802 implemented as a voting scheme. In this circuit, the FFCL function of a neuron/filter may be realized as a weighted linear combination of a number of voting sub-blocks, where each logic sub-block has been trained to distinguish a subset of the output classes of the neural network from all remaining output classes.

In another embodiment, a circuit for performing computations in a CNN is provided. In this embodiment, the network layers have been decomposed into at least two classes: MAC-based and FFCL layers. The arrangement in FIG. 21 shows the block diagram of an exemplary design of a Neural Network Processing Circuit 105 according to this embodiment, comprising the Logic Computation Units 2101, Tensor Computation Units 2102, and Vector Computation Units 2103.

In Logic Computation Units 807, each logic computation unit is configured to receive Boolean or multi-valued logic input activations for each neuron in the FFCL layers and generate an intermediate Boolean or multi-valued logic output activation by applying Boolean or multi-valued logic operations on the input activations. In Tensor Computation Units 805, each tensor computation unit is configured to receive connection weights and input activations for neurons in the MAC-based layers and generate (intermediate) output values for the neurons by applying arithmetic multiplication and addition operations on the connection weights and input activations. Finally, there are Vector Computation Units 806 coupled to the Tensor Computation Units 805, where each vector computation unit is configured to do further accumulation of (intermediate) output values if needed, and subsequently, apply a nonlinear activation function to the output value for each neuron to generate an output activation for each neuron in the MAC-based layers.

The neural network processing circuit 102 also optionally includes a 1-D matrix computation array coupled to the logic computation array, each matrix computation unit configured to apply an affine transformation followed by a second nonlinear activation function to the output activations to generate the (final) output activations for neurons in the FFCL layers.

The neural network processing circuit 105 also includes an array of signal conversion units placed between the vector computation array or the tensor computation array of a MAC-based layer on one hand and the matrix computation array of an FFCL layer on the other hand when the said two layers feed into one another. FIG. 21 depicts these arrays of matrix computations 2104 and signal conversions units 2105 within the neural network processing circuit 105. Each signal conversion unit itself is configured to apply a domain transformation between the first data and second data representation domains. The signal conversion unit converts data between higher- and lower- precision layers, e.g., the 16-bit fixed-point representation for the MAC-based layers versus the 1-bit representation for FFCL layers.

Data conversions from FCCL layers to MAC-based layers consist of multiplexers (MUX) that are used for converting data from low-precision to high-precision data formats. The low-precision data is used as a selector for this MUX. The high-precision value is as follows:

$$y = \left\{\begin{matrix}{α}_{N S} & \text{if} x = 1 , \\ 0 & \text{otherwise,}\end{matrix}\right)$$

where α_{NS} is the cached result from the training process. The α_{NS} is represented in the high-precision format.

Data conversion units for connecting MAC-based layers to FFCL layers are comparators that convert data from high-precision to low-precision data formats. The high-precision data is compared to α_{SN}, which is similarly obtained from the training process. The low-precision value is then calculated as:

$$y = \left\{\begin{matrix}1 & \text{if} x \geq {α}_{N S} , \\ 0 & \text{otherwise} \text{.}\end{matrix}\right)$$

Similar to α_{NS}, α_{SN} is represented in the high-precision format. Note that The α values are the same for all feature maps in a neural network layer. These values can be different in the case of multiple conversions between FFCL and MAC-based layers.

While specific configurations and arrangements for the signal conversions units 2105 were discussed above, it is understood that this description was provided for illustrative purposes only. Persons skilled in the relevant art will recognize that other configurations and arrangements may be employed without departing from the spirit and scope of the description.

A neuron in any of the neural network layers may be realized by using standard or custom logic cells in an application-specific integrated circuit, k-input look-up tables in a field programmable gate array device, or gate-level operation commands in a digital signal processor, a graphics processing unit, or a general purpose central processing unit. Moreover, the circuit includes one or more integrated on-chip memory units, each memory unit configured to hold any or all input and output activations for each neuron in each neural network layer. For MAC-based layers, on-chip memory units also stores the weights required for MAC operations. FIG. 21 depicts the integrated memory units 2106.

In this circuit, the logic computation units 2101 execute Boolean or multi-valued logic operations corresponding to Boolean or multi-valued logic function of a neuron in an FFCL layer, the function describing logic behaviors of output signal lines carrying the output activation of the neuron in terms of input signal lines carrying the input activations of the neuron. In this circuit, the number of input activations to each neuron in an FFCL layer is upper bounded by a pre-specified input count value for the neuron, where the value is lower than the number of neurons in the preceding neural network layers that couple into the neuron (e.g., through direct connections, single-hop, or multi-hop skip connections). Moreover, the logic computation unit 2101 may perform a maximum pooling operation to calculate the largest value in each patch (e.g., of size 3×3 or 5×5) of a map of output activations of any convolutional FFCL layers.

The circuit may be set up such that a logic computation unit 807 is configured to receive Boolean or multi-valued logic input activations for a first neural network layer and directly generate a plurality of Boolean or multi-valued logic output activations for a second neural network layer. In this case, the corresponding logic function is obtained based on the activation values seen during the training process for the input of the first layer, and the output of the second layer. In an important use case, the first neural network layer, the second neural network layer, and all intervening layers between the first and the second layers are FFCL layers.

In this circuit, the FFCL function of a neuron/filter may be realized as a weighted linear combination of a number of logic sub-blocks (e.g., voting sub-blocks), where each voting sub-block implements a subset of the logic function of the neuron/filter. The logic function here refers to the mapping from input activations to output activations for the neuron/filter. For example, each voting sub-block may be trained to help distinguish a subset of the output classes from all remaining output classes of the neural network.

In another embodiment, a circuit for performing neural network computations in a (deep) neural network is provided. Characteristically, the network layers are classified as one of two types: MAC-based or FFCL. The circuit itself comprises (i) a tensor computation array 2202, each tensor computation unit 2202 configured to receive connection weights and input activations for neurons in a MAC-based layer and generate accumulated output values for the neurons by doing MAC operations on input connection weights and input activations, (ii) a vector computation array 2203 coupled to the tensor computation array, each vector computation unit 2203 configured to do further accumulation (if needed) and subsequently apply a first nonlinear activation function to the accumulated output value for each neuron to generate an output activation for the neuron, (iii) a logic computation array 2201, each logic computation unit 2201 configured to receive Boolean or multi-valued logic input activations for each neuron in an FFCL layer and generate an intermediate Boolean or multi-valued logic activation for the neuron by applying Boolean or multi-valued logic operations on the input activations for the neuron, and (iv) a matrix computation array 2204 coupled to the logic computation array 2201, each matrix computation unit configured to apply an affine transformation followed by a second nonlinear activation function to the plurality of intermediate activations to generate the (final) output activation for each neuron in an FFCL layer. Note that the matrix computation unit 2204 may also be configured to apply an identity transformation to the intermediate output activations to trivially produce the output activations for each neural network layer in the FFCL layers. The arrangement in FIG. 22 shows the block diagram of an exemplary design of a Neural Network Processing Circuit 105 according to this embodiment, comprising the Logic Computation Units 2201, Tensor Computation Units 2202, Vector Computation Units 2203, and Matrix Computation Units 2204.

The circuit further includes an array of signal conversion units 2205 placed between the tensor computation unit 2202 (or the vector computation unit 2203) of a MAC-based layer and the matrix computation unit (or the logic computation unit 2201) of an FFCL layer if the said two layers feed into one another. Each signal conversion unit 2205 is configured to apply a domain transformation between the first data and second representation domains for output and input activations. Signal Conversion Units 2205 can be seen in the arrangement of FIG. 22.

A neuron in any neural network layers may be realized by using standard or custom logic cells in an application-specific integrated circuit, k-input look-up tables in a field programmable gate array device, or gate-level operation commands in a digital signal processor, a graphics processing unit, or a general purpose central processing unit.

The circuit may include one or more integrated memory units, each memory unit configured to hold any or all input and output activations for each neural network layer. Integrated Memory Units 2206 can be seen in the arrangement of FIG. 22.

The logic computation units 2201 execute Boolean or multi-valued logic operations corresponding to Boolean or multi-valued logic functions of neurons in an FFCL layer, the functions describing logic behaviors of output signal lines carrying the output activations in terms of input signal lines carrying the input activations for every neuron. These logic functions are obtained by two-level and multi-level logic minimization tools. In a refinement, if the Boolean or multi-valued logic functions for at least one neural network layer are Boolean, each of these functions has an offset size that is larger than its onset size. Moreover, the number of input activations for each neuron in an FFCL layer is upper bounded by a pre-specified input count value for the neuron, where the value is lower than the number of neurons in the preceding neural network layers that couple into the layer. The logic computation units 2201 may additionally perform a maximum pooling operation to calculate the largest value in each patch of a map of output activations of any convolutional FFCL layers.

One or more logic computation units 2201 may be configured to receive Boolean or multi-valued logic input activations for neurons in a first layer and directly generate Boolean or multi-valued logic output activations for neurons in a second layer. Note that the first neural network layer, the second neural network layer, and all intervening layers between the first and the second layers may be FFCL layers.

In another embodiment, a circuit for performing neural network computations in a (deep) neural network is provided. Characteristically, the network layers are classified as one of two types: MAC-based or FFCL. The circuit itself comprises (i) a tensor computation array, each tensor computation unit 2302 configured to receive connection weights and input activations for neurons in a MAC-based layer and generate accumulated output values for the neurons by doing MAC operations on input connection weights and input activations, (ii) a vector computation array 2303 coupled to the tensor computation array, each vector computation unit configured to do further accumulation (if needed) and subsequently apply a first nonlinear activation function to the accumulated output value for each neuron to generate an output activation for the neuron, (iii) a logic computation array 2301, each logic computation unit 2301 configured to receive Boolean or multi-valued logic input activations for each neuron in an FFCL layer and generate an intermediate Boolean or multi-valued logic activation for the neuron by applying Boolean or multi-valued logic operations on the input activations for the neuron, and (iv) and array of signal conversion units 2304 placed between the output activations of a first layer and the input activations of a second layer in the neural network when the first layer’s output activations have a first data representation format and are coupled to the second layer’s input activations which have a possibly-different second data representation format. Each signal conversion unit configured to apply a domain transformation between the first and second data representation formats. Note that the first and second data representations may be the same, in which case each signal conversion unit is configured to apply an identity transformation between the first data and second representation domains. The arrangement in Figs/nn_circuits/nn_circuit4 shows the block diagram of an exemplary design of a Neural Network Processing Circuit 105 according to this embodiment, comprising the Logic Computation Units 2301, Tensor Computation Units 2302, Vector Computation Units 2303, and Signal Conversion Units 2304.

The circuit includes a matrix computation array 2305 coupled to the logic computation array, each matrix computation unit configured to apply an affine transformation followed by a second nonlinear activation function to the plurality of intermediate activations to generate the output activation for each neuron in an FFCL layer. Note that the matrix computation unit 2305 may also be configured to apply an identity transformation to the intermediate output activations to trivially produce the (final) output activations for each neural network layer in the FFCL layers. Matrix Computation Units 2305 can be seen in the arrangement in FIG. 23.

A neuron in any neural network layers may be realized by using standard or custom logic cells in an application-specific integrated circuit, k-input look-up tables in a field programmable gate array device, or gate-level operation commands in a digital signal processor, a graphics processing unit, or a general purpose central processing unit.

The circuit may include one or more integrated memory units 2306, each memory unit configured to hold any or all input and output activations for each neural network layer. Integrated Memory Units 2306 can be seen in the arrangement in FIG. 23.

In this circuit, the logic computation units 2301 execute Boolean or multi-valued logic operations corresponding to Boolean or multi-valued logic functions of neurons in an FFCL layer, the functions describing logic behaviors of output signal lines carrying the output activations in terms of input signal lines carrying the input activations for every neuron. In this circuit, the number of input activations for each neuron in an FFCL layer is upper bounded by a pre-specified input count value for the neuron, where the value is lower than the number of neurons in the preceding neural network layers that couple into the layer. Moreover, The logic computation units 2301 may additionally perform a maximum pooling operation to calculate the largest value in each patch of a map of output activations of any convolutional FFCL layers.

One or more logic computation units 2301 may be configured to receive Boolean or multi-valued logic input activations for neurons in a first layer of a network (which is closer to the network inputs) and directly generate Boolean or multi-valued logic output activations for neurons in a second, potentially non-adjacent layer (which is closer to the network outputs). In this case, the corresponding logic function is obtained based on the activation values seen during the training process for the inputs of the first layer and the outputs of the second layer. Note that the first neural network layer, the second neural network layer, and all intervening layers between the first and the second layers are FFCL layers.

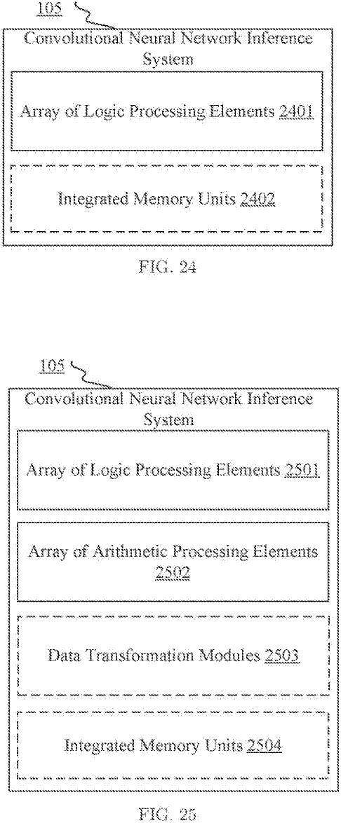

In another embodiment, a system for performing computations in a CNN inference is provided. The system includes one or more logic processing elements 2401, each logic processing element 2401 is configured to receive Boolean or multi-valued logic input values and generate a plurality of Boolean or multi-valued logic output values by applying Boolean or multi-valued logic operations. The arrangement in FIG. 24 shows the block diagram of an exemplary design of a Convolutional Neural Network Inference System 105 for this case, comprising an array of Logic Processing Elements 2401, alongside the Integrated Memory Units 2402.

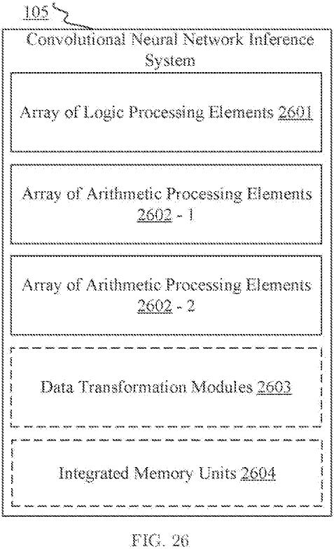

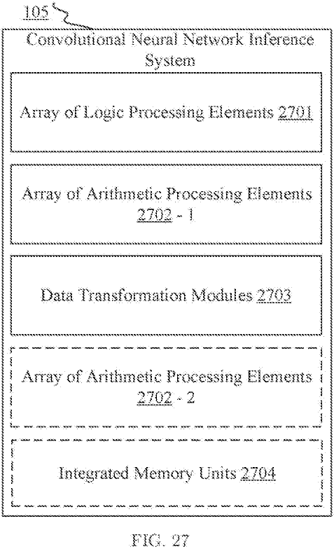

In another embodiment, a system for performing computations in a CNN is provided. In this embodiment, the network layers have been decomposed into at least two classes: MAC-based and FFCL layers. The arrangement in FIG. 25 shows the block diagram of an exemplary design of a Convolutional Neural Network Inference System 105 according to this embodiment, comprising an Array of Logic Processing Elements 2501, and an Array of Arithmetic Processing Elements 2502, alongside the Integrated Memory Units 2504.

Each arithmetic processing element in the Array of Arithmetic Processing Elements 2502 is configured to perform addition, multiplication, pooling, batch normalization, and nonlinear transformation for a layer in the MAC layers. Each logic processing element in Array of Logic Processing Elements 2501 is configured to perform Boolean or multi-valued logic operations for the FFCL layers.

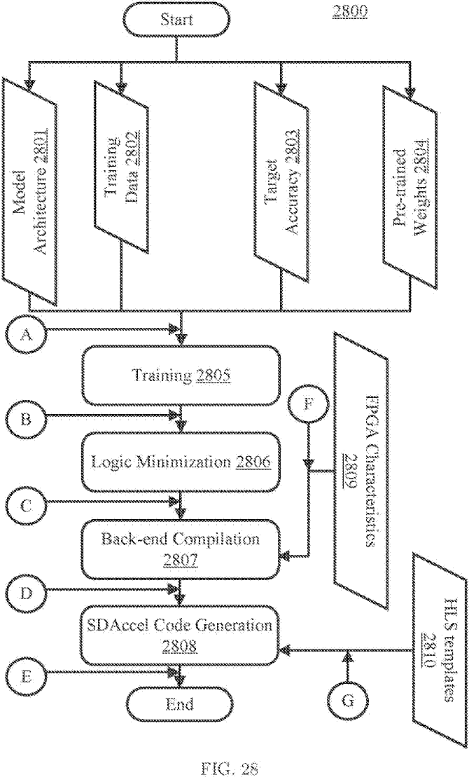

In another embodiment, a system for perfoming computations in a CNN is provided. In this embodiment, network layers have been decomposed into at least two classes: MAC-based and FFCL layers. The arrangement in FIG. 26 shows the block diagram of an exemplary design of a Convolutional Neural Network Inference System 105 according to this embodiment, comprising an Array of Logic Processing Elements 2601, a first Array of Arithmetic Processing Elements 2602-1, and a second Array of Arithmetic Processing Elements 2602-2, alongside the Integrated Memory Units 2604.

Each arithmetic processing element in the first Array of Arithmetic Processing Elements 2602-1 is configured to perform addition, multiplication, pooling, batch normalization, and nonlinear transformation for the MAC layers. Each logic processing element in the Array of Logic Processing Elements 2601 is configured to perform Boolean or multi-valued logic operations for the FFCL layers. Each arithmetic processing elements in the second Array of Arithmetic Processing Elements 2602-2 is configured to perform addition, multiplication, pooling, batch normalization, and nonlinear transformation on the outputs of the Array of Logic Processing Elements 2601 for some of the FFCL layers.

In another embodiment, a system for performing computations in a CNN is provided. In this embodiment, the network layers have been decomposed into at least two classes: MAC-based and FFCL layers. The arrangement in FIG. 27 shows the block diagram of an exemplary design of a Convolutional Neural Network Inference System 105 according to this embodiment, comprising an Array of Logic Processing Elements 2701, an Array of Arithmetic Processing Elements 2702-1, and an Array of Data Transformation Modules 2703, alongside the Integrated Memory Units 2704.

Each arithmetic processing element in the Array of Arithmetic Processing Elements 2702-1 is configured to perform addition, multiplication, pooling, batch normalization, and nonlinear transformation for the MAC layers. Each logic processing element in the Array of Logic Processing Elements 2701 is configured to perform Boolean or multi-valued logic operations for FFCL layers. The Array of Data Transformation Modules 2703 selectively converts data representation formats for the outputs of the Array of Arithmetic Processing Elements 2702-1 that feed directly into the inputs of the Array of Logic Processing Elements 2701 and vice versa.

In still another embodiment, a method of optimizing a convolutional neural network is provided. The method includes steps of:
a. assigning neural network layers to a first plurality or a second plurality of neural network layers;
b. producing output activations of a first plurality of neural network layers by performing arithmetic operations, including addition/subtraction and multiplication to do computations of sublayers within the first plurality of neural network layers, including any required linear or convolutional computations, pooling, batch normalization, and nonlinear transformation;
c. producing Boolean or multi-valued output activations of the second plurality of neural network layers by performing Boolean or multi-valued logic operations on Boolean or multi-valued input activations of the second plurality of neural network layers. In a variation, an assignment of a neural network layer to the first plurality of neural network layers or the second plurality of neural network layers is done based on a sensitivity analysis of neural network output accuracy to the bit precision of the layer.

In a variation, the activation functions used for processing the first plurality of neural network layers and the second plurality of neural network layers are different. In a refinement, the activation function used for processing the second plurality of neural network layers is a parameterized hard tangent hyperbolic function.

In a variation, a Boolean or multi-valued function of each neuron in each layer of the second plurality of neural network layers is obtained by
a. constructing a many-to-one mapping which relates input activations to the output activation of a neuron; and
b. performing two-level and multi-level logic optimizations to achieve a low-cost representation of the many-to-one mapping. In a refinement, the many-to-one mapping for each neuron is obtained by enumerating all or a subset of all possible input activations for the neuron. In a further refinement, the subset of all possible input activations is derived from a training data set for the neural network, is obtained based on a sampling of the training data set, or is generated synthetically from the training data set. In some refinement, the many-to-one mapping for each neuron is a truth table whereby each entry in the truth table comprises input activations and an output activation where the input activations are values observed at the inputs of the neuron for each input patch and each data point in the full, sampled or synthetically-generated training data set and the output activation is produced by doing any required linear or convolutional computations, pooling, batch normalization, and nonlinear transformation on the input activations. The synthetic method can generate new training data based on Data Shapley [70] values of data in the training data set. Typically, the sampling method favors sample selection around the mean value or support vector machine values of the training data set.

The truth table can describe an incompletely-specified Boolean or multi-valued logic function, in which don’t cares correspond to input activations that are not encountered during the training phase of the neural network. Moreover, the two-level and multi-level logic optimizations are done in such a way that the Boolean or multi-valued logic function of each neuron is only approximately equal to the truth table representation of the neuron.

In still another embodiment, a method of optimizing a neural network is provided. The method includes steps of:
a. assigning neural network layers to a first plurality or a second plurality of neural network layers;
b. producing output activations for the first plurality of neural network layers by performing arithmetic operations including addition, multiplication, pooling, batch normalization, and nonlinear transformation operations; and
c. producing output activations for the second plurality of neural network layers by performing Boolean or multi-valued logic operations on Boolean or multi-valued input activations of the second plurality of neural network layers to produce Boolean or multi-valued intermediate activations followed by additional arithmetic operations involving the intermediate activations to do the required computations of additional sublayers within the second plurality of neural network layers including linear and nonlinear transformation sublayers. In a variation, an assignment of a neural network layer to the first plurality of neural network layers or the second plurality of neural network layers is done based on a sensitivity analysis of neural network output accuracy to the bit precision of the layer. Typically, the activation functions used for processing the first plurality of neural network layers and the second plurality of neural network layers are different. Moreover, the activation function used for processing the second plurality of neural network layers can be a parameterized hard tangent hyperbolic function.

In a variation, a Boolean or multi-valued function of each neuron in each layer of the second plurality of neural network layers is obtained by
a. constructing a many-to-one mapping which relates input activations to the output activation of a neuron; and
b. performing two-level and multi-level logic optimizations to achieve a low-cost representation of the many-to-one mapping. Advantageously, the many-to-one mapping for each neuron is obtained by enumerating all or a subset of all possible input activations for the neuron. In a refinement, the subset of all possible input activations is derived from a training data set for the neural network, is obtained based on a sampling of the training data set, or is generated synthetically from the training data set. In a further refinement, the many-to-one mapping for each neuron is a truth table whereby each entry in the truth table comprises input activations and an output activation, the input activations are values observed at the inputs of the neuron for each input patch and each data point in the full, sampled or synthetically-generated training data set and the output activation is produced by doing any required linear or convolutional computations, pooling, batch normalization, and nonlinear transformation on the input activations. As set forth above, the truth table can describe an incompletely-specified Boolean or multi-valued logic function, in which don’t cares correspond to input activations that are not encountered during the training phase of the neural network. Moreover, the two-level and multi-level logic optimizations are done in such a way that the Boolean or multi-valued logic function of each neuron is only approximately equal to the truth table representation of the neuron. Also as set forth above, the sampling method favors sample selection around the mean value or support vector machine values of the training data set. Finally, the synthetic method can generate new training data based on Data Shapley values of data in the training data set.

In yet another embodiment, a method of optimizing a neural network is provided. The method includes steps of:
a. assigning neural network layers to a first plurality or a second plurality of neural network layers;
b. producing output activations of the first plurality of neural network layers by performing arithmetic operations, including addition/subtraction and multiplication to do computations of sublayers within the first plurality of neural network layers, including any required linear or convolutional computations, pooling, batch normalization, and nonlinear transformation;
c. producing Boolean or multi-valued output activations of the second plurality of neural network layers by performing Boolean or multi-valued logic operations on Boolean or multi-valued input activations of the second plurality of neural network layers; and
d. selectively converting data representation formats for the output activations of a group of neural network layers that feed directly into a first neural network layer to a required data representation format for the input activations of the first neural network layer. In a variation, an assignment of a neural network layer to the first plurality of neural network layers or the second plurality of neural network layers is done based on a sensitivity analysis of neural network output accuracy to the bit precision of the layer. In a refinement, the activation functions used for processing the first plurality of neural network layers and the second plurality of neural network layers are different. In a further refinement, the activation function used for processing the second plurality of neural network layers is a parameterized hard tangent hyperbolic function.

In a variation, a Boolean or multi-valued function of each neuron in each layer of the second plurality of neural network layers is obtained by
a. constructing a many-to-one mapping which relates input activations to the output activation of a neuron; and
b. performing two-level and multi-level logic optimizations to achieve a low-cost representation of the many-to-one mapping. Advantageouly, the many-to-one mapping for each neuron is obtained by enumerating all or a subset of all possible input activations for the neuron. Moreover, the subset of all possible input activations can be derived from a training data set for the neural network, is obtained based on a sampling of the training data set, or is generated synthetically from the training data set. In a refinement, the many-to-one mapping for each neuron is a truth table whereby each entry in the truth table comprises input activations and an output activation, the input activations are values observed at the inputs of the neuron for each input patch and each data point in the full, sampled or synthetically-generated training data set and the output activation is produced by doing any required linear or convolutional computations, pooling, batch normalization, and nonlinear transformation on the input activations. Advantageously, the synthetic method generates new training data based on Data Shapley values of data in the training data set. The truth table describe an incompletely-specified Boolean or multi-valued logic function, in which don’t cares correspond to input activations that are not encountered during the training phase of the neural network. As set forth above, the two-level and multi-level logic optimizations are done in such a way that the Boolean or multi-valued logic function of each neuron is only approximately equal to the truth table representation of the neuron. Also as set forth above, the sampling method favors sample selection around the mean value or support vector machine values of the training data set.

Additional detail can be found in a M. Nazemi et al, NullaNet Tiny: Ultra-low-latency DNN Inference Through Fixed-function Combinational Logic, arXiv:2104.05421v1 [cs.LG] 7 Apr. 2021 which is attached as Exhibit A; the entire disclosure of which is hereby incorporated by reference.

The following examples illustrate the various embodiments of the present invention. Those skilled in the art will recognize many variations that are within the spirit of the present invention and scope of the claims.

### HyFEN Compiler and Some Results

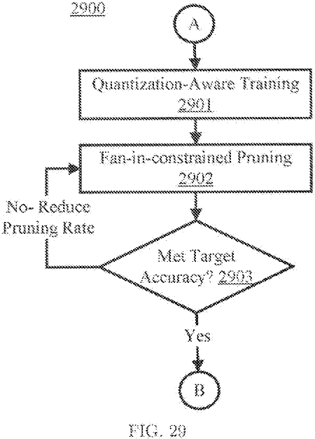

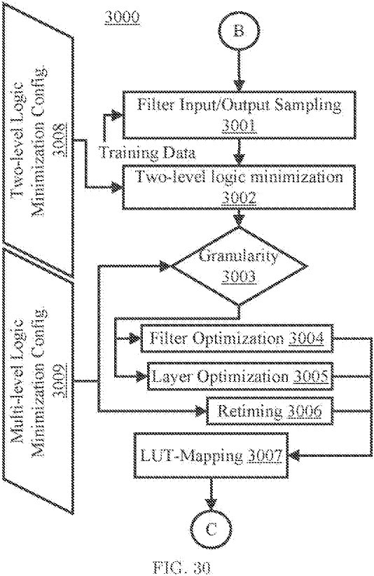

A brief description of the four main components of the HyFEN compiler, which is provided next, demonstrates how upstream components take account of downstream components while performing various optimizations (as shown in FIG. 28). In this exemplary HyFEN compiler workflow, activations are typically quantized to (scaled) binary (0 and 1), bipolar (-1 and +1), or multiple-valued (e.g., 0, 1, 2, and 3) values whereas model parameters are left in floating-point representation. Therefore, while the HyFEN compiler divides the optimization process into logically separate components, it has a holistic approach to efficient processing of DNNs. Such an end-to-end solution enables unprecedented levels of energy-efficiency and low latency while maintaining acceptable levels of classification accuracy. The training module (as shown in FIG. 29) is responsible for both quantization-aware training and fanin-constrained pruning. Quantization-aware training refers to the quantization of activations to binary, bipolar, or multi-bit values during the training of a neural network. Fanin-constrained pruning, as its name suggests, limits the number of inputs to a filter/neuron to prevent the logic minimization step from running into scalability issues. Because each filter/neuron that is mapped to FFCL blocks has to be optimized using two-level logic minimization and because the computational complexity of heuristic two-level logic minimization is super-linear in its input variable count, constraining the number of inputs to that filter/neuron is a critical task. The fanin-constrained DNN pruning may be accomplished by either the alternating direction method of multipliers (ADMM) of [3] or the gradual pruning of [69]. Notice that fanin-constrained pruning does not have to be done after the quantization-aware training. In fact, quantization-aware training and fanin-constrained pruning can be combined into a single step to speed up the training process.

The logic minimization module (as shown in FIG. 30) comprises two main modules, the two-level logic minimization and the multi-level logic minimization. The two-level logic minimization module creates truth tables that represent the (approximate) functions of different neurons/filters either by enumerating all their input combinations or through examining their inputs and outputs when (a subset of) the training data is applied to the trained model. Moreover, the truth tables may be created for a subset of neurons/filters of a given layer, one full layer, or a group of consecutive DNN/CNN layers. After this step, the module passes the truth tables to a suite of exact and/or approximate two-level logic minimization algorithms that harden the functions of neurons/filters into fixed-function, combinational logic blocks. The optimized combinational logic no longer requires access to the parameters (i.e., weights) of neurons/filters. The multi-level logic minimization optimizes neurons/filters in a subset of neurons/filters within a specific layer, all neurons/filters in exactly one layer, or all neurons/filters in a group of consecutive layers by applying multi-level logic restructuring techniques such as decomposition, common sub-expression extraction, and elimination. This step is optionally followed by a target-specific technology mapping step, that maps the logic operations to a base set of simple 2-input logic functions that is functionally complete to two- and multi-input logic gates in a cell library.

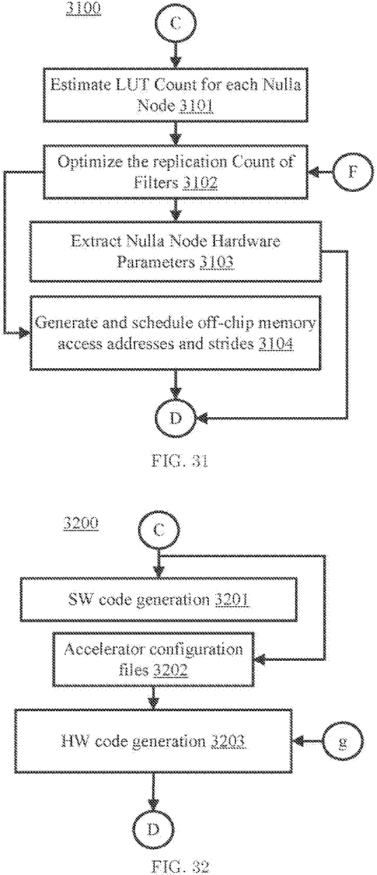

The back-end compilation module (as shown in FIG. 31) performs optimizations tailored to the employed accelerator design realizing FFCL blocks for the implementation of the inference graph. The proposed compiler takes a neural network model, converts it to a computational graph, schedules its operations, and more importantly, optimizes its nodes by leveraging intrinsic fusion of different required operations such as convolution or fully-connected layer computations with batch normalization. Next, the compiler decides about various loop optimizations (including tiling, reordering, and parallelizing the nested loops of computational block) for each layer that is mapped to the MPEs. In the case of a FFCL layer, this module also determines the number of FFCL block replications that are employed for each layer. The idea behind FFCL block replication is that in order to speed up the processing of the many patches of an input feature map in a CNN, one can replicate the FFCL block realization of the filters a few times (e.g., by creating t copies of each filter in the CNN layer), and thereby, reduce the processing time of the FFCL layer by a factor of t at the cost of a factor of t increase in the hardware resource usage for realizing filters in the CNN layer. After these optimizations, the module compiles the information from the optimizer and extracts the required parameters for the accelerator design and generates a static kernel execution schedule.

The SDAccel code generation module (as shown in FIG. 32) comprises software (SW) and hardware (HW) code generation modules. In the SDAccel framework, an application program is split between a host application and hardware accelerated kernels with a communication channel between them. The host application, which is written in C/C++ and uses API abstractions like OpenCL, runs on a CPU while the kernels run on the FPGA device(s). Host code, which provides an interface to allow data transfer from the host machine to kernels, follows the OpenCL programming paradigm and is structured into three code sections for (a) setting the environment, (b) enqueuing kernels for their executions, and (c) post-processing and releasing the resources. The SW generator takes the kernel schedule and generates C++/OpenCL codes for the host, which is in charge of the kernel execution scheduling, model initialization, data buffer management, and so on. Finally, the HW generator wraps the RTL kernels generated at the end of the logic minimization module in HLS templates and generates synthesizable hardware code.

The hyFEN compiler can employ different activation functions for different layers to yield higher accuracy. For example, if the inputs to a DNN assume both negative and positive values, we employ an activation function such as the sign function or a parameterized hard tanh (PHT) function to better capture the range of inputs. On the other hand, if a set of values can only assume non-negative numbers, we rely on the parameterized clipping activation (PACT) [10] function to quantize activations. The same consideration is taken into account when quantizing the outputs of the last layer which are fed to a softmax function.

The FFCL layers in the HyFEN fabric have fixed-function, combinational logic behavior, which are different from one another. Therefore, we need different hardware resources for each FFCL layer, i.e., we cannot reuse the computational logic from one layer to another (this is an instance of the streaming architecture for DNN/CNN hardware realization). FIG. 7 shows N consecutive layers realized using the HyFEN fabric. If the first FFCL layer is the first layer of the network, input feature maps for the first layer should be transferred from dynamic random access memory (DRAM) to its on-chip RAM. Next, for each layer the data is read from the on-chip RAMs and moved to the register files, which serve as the input for the custom combinational logic. The output of the computation is written to the output register files and then the output on-chip RAMs for the layer. For each layer, by iterating over the input on-chip RAM and bringing different input data patches to registers, performing the required logic operations, and storing the results from output registers to output on-chip RAMs, the required computation for each FFCL layer is completed.

The number of iterations for each FFCL layer of a CNN depends on (i) dimensions of the input feature map, (ii) size of the patches, and (iii) number of times the custom combinational logic is replicated in hardware for the layer. As explained above, these replicas enable parallel processing of more than one patch of the input in each iteration. Note that, in fully-connected layers (e.g., last two layers in FIG. 7), there is only one copy of each combinational function and one iteration, so feature maps are not stored in the on-chip RAM and can be accessed directly from registers.

For evaluation purposes, the HyFEN framework targeted a Xilinx VU9P FPGA in the cloud (available on the AWS EC2 F1 instance). This FPGA platform includes 64 GiB DDR4 ECC protected memory, with a dedicated PCIe x16 connection. There are four DDR banks. This FPGA contains approximately 2.5 million logic elements and approximately 6,800 DSP units⁵. Input images are sent using PCIe from the host CPU to the on-board DDR4, accessible by the accelerator, and the output results are sent back to the host CPU.

⁵ https://aws.amazon.com/education/F1-instances-for-educators/

First, we evaluate the HyFEN framework against extreme-throughput tasks in physics and cybersecurity such as jet substructure classification and network intrusion detection. We use Xilinx Vivado 2019.1 in the out-of-context mode with Flow_PerfOptimized_high for synthesis and Performance_Explore for place and route without any manual placement constraints. We constrained the clock cycle time to 1 ns to achieve the highest possible frequency.

We also evaluated the HyFEN framework on a well-known CNN, i.e., VGG16 and a commonly used computer-vision dataset for object recognition i.e., the CIFAR-10 dataset. As a baseline for the state-of-the-art generic MAC array-based accelerator for the layers realized using

conventional MAC calculations, we used the open-source implementation of [53] with some modifications including transferring all weights required for the computation of the layer from the external memory into on-chip RAMs, where these weights get reused for calculations corresponding to different patches of input feature maps. Furthermore, partial sums of accumulation for processing the output of a filter/neuron are also stored in the register file of the same processing element. Considering these modifications, we reduce the latency of VGG-16 inference employing the generic MAC array-based accelerator.

Table 0.1: Layer-by-layer latency improvements achieved by using HyFEN and FFCL layers for VGG-16

| | | | | | | |
|---|---|---|---|---|---|---|
| Method | Layer 8 | Layer 9 | Layer 10 | Layer 11 | Layer 12 | Layer 13 |
| HyFEN | 1.5 µs | 1.5 µs | 1.5 µs | 0.24 µs | 0.39 µs | 0.39 µs |
| MAC | 384 µs | 772 µs | 769 µs | 753 µs | 760 µs | 756 µs |

We use the Xilinx Power Analyzer (XPA) tool integrated into Vivado with default settings, that is commonly used for early power estimation [14], to assess the power consumption of each design.

Jet Substructure Classification (JSC): Collisions in hadron colliders result in color-neural hadrons formed by a combination of quarks and gluons. These are observed as collimated spray of hadrons which are referred to as jets. The Jet Substructure Classification is the task of finding interesting jets from large jet substructures. We use the 16-inputs and 5-outputs classification formulation of Duarte et al [17] for JSC. Processing such collisions requires architectures that operate at or above a 40 MHz clock frequency and have a sub-microsecond latency. For JSC task, the HyFEN framework achieves 72.33% accuracy, which is higher than state-of-the-art reported accuracy achieved for JSC task using networks containing FFCL layers, along with 9× improvements in LUT with up to 3× decrease in flip-flops (FF) usage.

Network Intrusion Detection (NID): Identifying suspicious packets is an important classification task in cybersecurity. Neural networks used for identifying malicious attacks need extreme throughput so as to not cause any bottlenecks in the network because the number of packets sent to a machine is in the order of millions per second. Therefore, these types of datasets are good benchmarks for the HyFEN framework as they need specialized hardware for seamless intrusion detection. For NID task, the HyFEN framework achieves 93.43% accuracy, which is higher than state-of-the-art reported accuracy achieved for NID task using networks containing FFCL layers, along with 24× improvements in LUT with up to 3× decrease in flip-flops (FF) usage.

We use VGG-16 with CIFAR-10 dataset as a case study for tasks with high-accuracy requirements. We implement intermediate convolutional layers 8-13 in VGG-16 using the HyFEN framework and fixed-function combinational logic functions. Table 0 shows the achieved layer-by-layer latency improvements compared to when implementing the said convolutional layers using the MAC array accelerator design. As illustrated in the table, We achieve significant savings in terms of layer-wise computational latency for intermediate convolutional layers 8-13 of VGG-16, which have large memory footprints (i.e., weights), compared to when implementing the said convolutional layers using the MAC array accelerator design. Using HyFEN, the total latency for layers 8-13 is reduced by around 760× compared to employing the MAC array accelerator design. Furthermore, the obtained accuracies using both of these approaches are relatively close. The model accuracy when layers 8-13 are mapped using MAC array accelerator design is obtained as 93.04%, while it is obtained as 92.26% when layers 8-13 are mapped using HyFEN

The computational latency of layers, when implemented with the MAC array accelerator design is mostly influenced by the corresponding number of weights rather than the intensity of on-chip computations (i.e., FLOPs). The number of weights for layers 9-13 in VGG-16 is equal to each other and twice the number of weights we have for layer 8. The same trend is observed in the latency values corresponding to the implementation with the MAC array accelerator design. Furthermore, when we implement the layers using the HyFEN framework, the computational latency of layers is mostly correlated with the width and height of their corresponding IFMs. The width and height of IFMs for layers 11-13 is half the width and height of IFMs for layers 8-10, respectively. The same trend is also observed in the latency values corresponding to the implementation with the HyFEN framework.

Furthermore, power consumption for the HyFEN solution is obtained as 8.6 W compared to 10.1 W for MAC array accelerator design. Considering the energy consumption, employing HyFEN leads to around 893× energy savings.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### References

[1] Avi Baum, Or Danon, and Daniel Chibotero. Structured weight based sparsity in an artificial neural network compiler, Sep. 10, 2020.

[2] Avi Baum, Or Danon, Hadar Zeitlin, Daniel Ciubotariu, and Rami Feig. Neural network processor incorporating separate control and data fabric, Oct. 4, 2018.

[3] Stephen P. Boyd, Neal Parikh, Eric Chu, Borja Peleato, and Jonathan Eckstein. Distributed optimization and statistical learning via the alternating direction method of multipliers. Foundations and Trends in Machine Learning, 3(1): 1-122, 2011.

[4] John Brady, Marco Mecchia, Patrick F. Doyle, and Stanislaw Jan Maciag. Hardware agnostic deep neural network compiler, Dec. 26, 2019.

[5] John Brady, Marco Mecchia, Patrick F. Doyle, Meenakshi Venkataraman, and Stanislaw Jan Maciag. Control of scheduling dependencies by a neural network compiler, Dec. 26, 2019.

[6] John W. Brothers and Joohoon Lee. Neural network processor, Jan. 12, 2017.

[7] Kurt F. Busch, III Jeremiah H. Holleman, Pieter Vorenkamp, and Stephen W. Bailey. Pulse-width modulated multiplier, Feb. 14, 2019.

[8] Pi-Feng Chiu, Won Ho Choi, Wen Ma, and Martin Lueker-Boden. Shifting architecture for data reuse in a neural network, Apr. 16, 2020.

[9] Ping Chi, Shuangchen Li, Cong Xu, Tao Zhang, Jishen Zhao, Yongpan Liu, Yu Wang, and Yuan Xie. PRIME: A novel processing-in-memory architecture for neural network computation in ReRAM-based main memory. In International Symposium on Computer Architecture, pages 27-39. IEEE Computer Society, 2016.

[10] Jungwook Choi, Zhuo Wang, Swagath Venkataramani, Pierce I-Jen Chuang, Vijayalakshmi Srinivasan, and Kailash Gopalakrishnan. PACT: parameterized clipping activation for quantized neural networks. CoRR, abs/1805.06085, 2018.

[11] Yoo Jin Choi, Mostafa El-Khamy, and Jungwon Lee. Method and apparatus for neural network quantization, Apr. 19, 2018.

[12] Dan C. Ciresan, Ueli Meier, and Jürgen Schmidhuber. Multi-column deep neural networks for image classification. In Conference on Computer Vision and Pattern Recognition, pages 3642-3649. IEEE Computer Society, 2012.

[13] William J. Dally, Angshuman Parashar, Joel Springer Emer, Stephen William Keckler, and Larry Robert Dennison. Sparse convolutional neural network accelerator, Dec. 8, 2020.

[14] James J. Davis, Joshua M. Levine, Edward A. Stott, Eddie Hung, Peter Y. K. Cheung, and George A. Constantinides. STRIPE: signal selection for runtime power estimation. In Marco D. Santambrogio, Diana Göhringer, Dirk Stroobandt, Nele Mentens, and Jari Nurmi, editors, 27th International Conference on Field Programmable Logic and Applications, FPL 2017, Ghent, Belgium, September 4-8, 2017, pages 1-8. IEEE, 2017.

[15] Jacob Devlin, Ming-Wei Chang, Kenton Lee, and Kristina Toutanova. BERT: pre-training of deep bidirectional transformers for language understanding. In Conference of the North American Chapter of the Association for Computational Linguistics: Human Language Technologies, pages 4171-4186. Association for Computational Linguistics, 2019.

[16] Xiaohan Ding, Guiguang Ding, Xiangxin Zhou, Yuchen Guo, Jungong Han, and Ji Liu. Global sparse momentum SGD for pruning very deep neural networks. In Advances in Neural Information Processing Systems, pages 6379-6391, 2019.

[17] Javier M. Duarte, Song Han, Philip C. Harris, Sergo Jindariani, Edward Kreinar, Benjamin Kreis, Jennifer Ngadiuba, Maurizio Pierini, Ryan Rivera, Nhan Tran, and Zhenbin Wu. Fast inference of deep neural networks in fpgas for particle physics. CoRR, abs/1804.06913, 2018.

[18] Thomas J. Duerig, Hongsheng Wang, and Scott Alexander Rudkin. Systems and methods for performing knowledge distillation, Dec. 24, 2020.

[19] Ali Farhadi and Mohammad Rastegari. System and methods for efficiently implementing a convolutional neural network incorporating binarized filter and convolution operation for performing image classification, Jun. 4, 2019.

[20] Laura Fick, David T. Blaauw, Dennis Sylvester, Michael B. Henry, and David Alan Fick. Floating-gate transistor array for performing weighted sum computation, Sep. 12, 2017.

[21] Takashi Fukuda, Samuel Thomas, and Bhuvana Ramabhadran. Soft label generation for knowledge distillation, Jul. 4, 2019.

[22] Mingyu Gao, Jing Pu, Xuan Yang, Mark Horowitz, and Christos Kozyrakis. TETRIS: scalable and efficient neural network acceleration with 3D memory. In Yunji Chen, Olivier Temam, and John Carter, editors, International Conference on Architectural Support for Programming Languages and Operating Systems, pages 751-764. ACM, 2017.

[23] Vinayak Gokhale et al. A 240 G-ops/s mobile coprocessor for deep neural networks. In Conference on Computer Vision and Pattern Recognition, pages 696-701. IEEE Computer Society, 2014.

[24] Richard HR Hahnloser, Rahul Sarpeshkar, Misha A Mahowald, Rodney J Douglas, and H Sebastian Seung. Digital selection and analogue amplification coexist in a cortex-inspired silicon circuit. Nature, 405(6789):947-951, 2000.

[25] Song Han, Jeff Pool, John Tran, and William J. Dally. Learning both weights and connections for efficient neural networks. CoRR, abs/1506.02626, 2015.

[26] Kazuma Hashimoto, Caiming Xiong, and Richard Socher. Deep neural network model for processing data through multiple linguistic task hierarchies, May 3, 2018.

[27] Geoffrey E. Hinton, Oriol Vinyals, and Jeffrey Dean. Distilling the knowledge in a neural network. CoRR, abs/1503.02531, 2015.

[28] Sepp Hochreiter and Jürgen Schmidhuber. Long short-term memory. Neural Computation, 9(8): 1735-1780, 1997.

[29] Gao Huang, Zhuang Liu, Laurens van der Maaten, and Kilian Q. Weinberger. Densely connected convolutional networks. In Conference on Computer Vision and Pattern Recognition, pages 2261-2269. IEEE Computer Society, 2017.

[30] Julian Ibarz, Yaroslav Bulatov, and Ian Goodfellow. Sequence transcription with deep neural networks, Sep. 27, 2016.

[31] Sergey Ioffe and Christian Szegedy. Batch normalization: Accelerating deep network training by reducing internal covariate shift. In Francis R. Bach and David M. Blei, editors, International Conference on Machine Learning, volume 37 of JMLR Workshop and Conference Proceedings, pages 448-456. JMLR.org, 2015.

[32] Duckhwan Kim, Jaeha Kung, Sek M. Chai, Sudhakar Yalamanchili, and Saibal Mukhopadhyay. Neurocube: A programmable digital neuromorphic architecture with high-density 3D memory. In International Symposium on Computer Architecture, pages 380-392. IEEE Computer Society, 2016.

[33] Alex Krizhevsky, Ilya Sutskever, and Geoffrey E. Hinton. ImageNet classification with deep convolutional neural networks. In Advances in Neural Information Processing Systems, pages 1106-1114, 2012.

[34] Alexey Kruglov. Channel pruning of a convolutional network based on gradient descent optimization, Dec. 17, 2020.

[35] Seungjin Lee, Sung Hee Park, and Elaina Chai. Compiling and scheduling transactions in neural network processor, Nov. 7, 2019.

[36] Dexu Lin, Venkata Sreekanta Reddy Annapureddy, David Edward Howard, David Jonathan Julian, Somdeb Majumdar, and II William Richard Bell. Fixed point neural network based on floating point neural network quantization, Aug. 6, 2019.

[37] Shikun Liu, Zhe Lin, Yilin Wang, Jianming Zhang, and Federico Perazzi. Neural network architecture pruning, Aug. 26, 2021.

[38] Warren S McCulloch and Walter Pitts. A logical calculus of the ideas immanent in nervous activity. The bulletin of mathematical biophysics, 5(4): 115-133, 1943.

[39] Asit K. Mishra and Debbie Marr. Apprentice: Using knowledge distillation techniques to improve low-precision network accuracy. In International Conference on Learning Representations. OpenReview.net, 2018.

[40] Asit K. Mishra, Eriko Nurvitadhi, Jeffrey J. Cook, and Debbie Marr. WRPN: wide reduced-precision networks. In International Conference on Learning Representations. OpenReview.net, 2018.

[41] Pavlo Molchanov, Stephen Walter Tyree, Tero Tapani Karras, Timo Oskari Aila, and Jan Kautz. Systems and methods for pruning neural networks for resource efficient inference, Apr. 26, 2018.

[42] Maryam Moosaei, Guy Hotson, Parsa Mahmoudieh, and Vidya Nariyambut Murali. Brake light detection, Dec. 1, 2020.

[43] Mahdi Nazemi, Ghasem Pasandi, and Massoud Pedram. Energy-efficient, low-latency realization of neural networks through boolean logic minimization. In Toshiyuki Shibuya, editor, Proceedings of the 24th Asia and South Pacific Design Automation Conference, ASPDAC 2019, Tokyo, Japan, January 21-24, 2019, pages 274-279. ACM, 2019.

[44] Antonio Polino, Razvan Pascanu, and Dan Alistarh. Model compression via distillation and quantization. In International Conference on Learning Representations. OpenReview.net, 2018.

[45] Mansi Rankawat, Jian Yao, Dong Zhang, and Chia-Chih Chen. Determining drivable free-space for autonomous vehicles, Sep. 19, 2019.

[46] Mohammad Rastegari, Vicente Ordonez, Joseph Redmon, and Ali Farhadi. XNOR-Net: ImageNet classification using binary convolutional neural networks. In European Conference on Computer Vision, volume 9908 of Lecture Notes in Computer Science, pages 525-542. Springer, 2016.

[47] Frank Rosenblatt. The perceptron: a probabilistic model for information storage and organization in the brain. Psychological review, 65(6):386, 1958.

[48] Jonathan Ross and Andrew Everett Phelps. Computing convolutions using a neural network processor, Oct. 8, 2019.

[49] Nadav Rotem, Jordan Fix, Saleem Abdulrasool, Summer Deng, Roman Dzhabarov, James Hegeman, Roman Levenstein, Bert Maher, Nadathur Satish, Jakob Olesen, Jongsoo Park, Artem Rakhov, and Misha Smelyanskiy. Glow: Graph lowering compiler techniques for neural networks. CoRR, abs/1805.00907, 2018.

[50] Ali Shafiee, Anirban Nag, Naveen Muralimanohar, Rajeev Balasubramonian, John Paul Strachan, Miao Hu, R. Stanley Williams, and Vivek Srikumar. ISAAC: A convolutional neural network accelerator with in-situ analog arithmetic in crossbars. In International Symposium on Computer Architecture, pages 14-26. IEEE Computer Society, 2016.

[51] Yakun Shao, Rangharajan Venkatesan, Miaorong Wang, Daniel Smith, William James Dally, Joel Emer, Stephen W. Keckler, and Brucek Khailany. Efficient neural network accelerator dataflows, Sep. 17, 2020.

[52] Hardik Sharma et al. From high-level deep neural models to fpgas. In International Symposium on Microarchitecture, pages 17:1-17:12. IEEE Computer Society, 2016.

[53] Atefeh Sohrabizadeh, Jie Wang, and Jason Cong. End-to-end optimization of deep learning applications. In Stephen Neuendorffer and Lesley Shannon, editors, FPGA ‘20: The 2020 ACM/SIGDA International Symposium on Field-Programmable Gate Arrays, Seaside, CA, USA, February 23-25, 2020, pages 133-139. ACM, 2020.

[54] Dave Steinkrau, Patrice Y. Simard, and Ian Buck. Using gpus for machine learning algorithms. In International Conference on Document Analysis and Recognition, pages 1115-1119. IEEE Computer Society, 2005.

[55] Xinyao Sun, Xinpeng Liao, Xiaobo Ren, and Haohong Wang. System and method for vision-based flight self-stabilization by deep gated recurrent Q-networks, Mar. 26, 2019.

[56] Vivienne Sze, Yu-Hsin Chen, Tien-Ju Yang, and Joel S. Emer. Efficient processing of deep neural networks: A tutorial and survey. Proceedings of the IEEE, 105(12):2295-2329, 2017.

[57] Lucas Theis, Iryna Korshunova, Alykhan Tejani, and Ferenc Huszar. Faster gaze prediction with dense networks and fisher pruning. CoRR, abs/1801.05787, 2018.

[58] Frederick Tung and Gregory Mori. System and method for knowledge distillation between neural networks, Sep. 24, 2020.

[59] Yaman Umuroglu, Yash Akhauri, Nicholas James Fraser, and Michaela Blott. Logicnets: Co-designed neural networks and circuits for extreme-throughput applications. In Nele Mentens, Leonel Sousa, Pedro Trancoso, Miquel Pericàs, and Ioannis Sourdis, editors, 30th International Conference on Field-Programmable Logic and Applications, FPL 2020, Gothenburg, Sweden, August 31 - Sep. 4, 2020, pages 291-297. IEEE, 2020.

[60] Stylianos I. Venieris and Christos-Savvas Bouganis. fpgaConvNet: Mapping regular and irregular convolutional neural networks on FPGAs. IEEE Transaction on Neural Networks and Learning Systems, 30(2):326-342, 2019

[61] Stylianos I. Venieris, Alexandros Kouris, and Christos-Savvas Bouganis. Toolflows for mapping convolutional neural networks on fpgas: A survey and future directions. ACM Comput. Surv., 51(3), June 2018.

[62] Naiyan Wang. Method and apparatus for neural network pruning, Sep. 12, 2019.

[63] Yu Wang, Fan Jiang, Xiao Sheng, Song Han, and Yi Shan. Method of pruning convolutional neural network based on feature map variation, Oct. 1, 2020.

[64] Xuechao Wei, Yun Liang, Xiuhong Li, Cody Hao Yu, Peng Zhang, and Jason Cong. TGPA: tile-grained pipeline architecture for low latency CNN inference. In Iris Bahar, editor, Proceedings of the International Conference on Computer-Aided Design, ICCAD 2018, San Diego, CA, USA, November 05-08, 2018, page 58. ACM, 2018.

[65] Seung-Soo Yang. Neural network system for reshaping a neural network model, application processor including the same, and method of operating the same, Mar. 14, 2019.

[66] Xuan Yang, Mingyu Gao, Jing Pu, Ankita Nayak, Qiaoyi Liu, Steven Bell, Jeff Setter, Kaidi Cao, Heonjae Ha, Christos Kozyrakis, and Mark Horowitz. DNN dataflow choice is overrated. CoRR, abs/1809.04070, 2018.

[67] Sergey Zagoruyko and Nikos Komodakis. Wide residual networks. In British Machine Vision Conference. BMVA Press, 2016.

[68] Gang Zhang. Method and apparatus for compressing neural network, Jul. 4, 2019.

[69] Michael Zhu and Suyog Gupta. To prune, or not to prune: Exploring the efficacy of pruning for model compression. In International Conference on Learning Representations. OpenReview.net, 2018.

[70] Amirata Ghorbani and James Zou. Data shapley: equitable valuation of data for machine learning. In International Conference on Machine Learning, 2019

What is claimed is:

1. A circuit for performing neural network computations in a neural network, the circuit configured with a first plurality of neural network layers and a second plurality of neural network layers, the circuit comprising:
a. one or more tensor computation units, each tensor computation unit configured to receive a plurality of input weights and a plurality of input activations for neurons in each neural network layer in the first plurality of neural network layers and generate a plurality of accumulated output values for neurons in the first plurality of neural network layers based on the plurality of input weights and the plurality of input activations by doing arithmetic addition and multiplication operations on input connection weights and input activations;
b. one or more vector computation units coupled to the one or more tensor computation units, each vector computation unit configured to apply a first nonlinear activation function to each value in the plurality of accumulated output values to generate a first plurality of output activations for each neural network layer in the first plurality of neural network layers; and
c. one or more logic computation units, each logic computation unit configured to receive a plurality of Boolean or multi-valued logic input activations for each neural network layer in the second plurality of neural network layers and generate a second plurality of Boolean or multi-valued logic activations for each neural network layer in the second plurality of neural network layers by applying Boolean or multi-valued logic operations on the input activations for each neural network layer in the second plurality of neural network layers.

2. The circuit of claim 1, wherein one or more layers in the first plurality of neural network layers or the second plurality of neural network layers are of convolutional type.

3. The circuit of claim 1, wherein the circuit includes one or more matrix computation units coupled to the one or more logic computation units, each matrix computation unit configured to apply an affine transformation followed by a second nonlinear activation function to the second plurality of Boolean or multi-valued logic activations for each neural network layer in the second plurality of neural network layers to generate a third plurality of output activations for each neural network layer in the second plurality of neural network layers.

4. The circuit of claim 1, wherein the circuit includes one or more signal conversion units existing between a tensor computation unit (or a vector computation unit) of a layer in the first plurality of neural network layers and a logic computation unit of another layer in the second plurality of neural network layers if said two layers feed into one another, each signal conversion unit configured to apply a data transformation between a first data representation domain for the input (or output) activations of the layer in the first plurality of neural network layers and a second representation domain for the output (or input) activations of the layer in the second plurality of neural network layers.

5. The circuit of claim 1, wherein one or more neurons in one or more of the neural network layers are realized by using standard or custom logic cells in an application-specific integrated circuit, k-input look-up tables in a field programmable gate array device, or gate-level operation commands in a digital signal processor, a graphics processing unit, or a general purpose central processing unit.

6. The circuit of claim 1, wherein the circuit includes one or more integrated memory units, each memory unit configured to hold any or all input and output activations for each neural network layer.

7. The circuit of claim 1, wherein one or more neurons in any neural network layers are realized as a weighted linear combination of a number of logic sub-blocks, where each logic sub-block implements a subset of an input-output logic function of the said one or more neurons.

8. The circuit of claim 1, wherein the number of input activations to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

9. The circuit of claim 1, wherein at least one of the one or more logic computation units is configured to receive the plurality of Boolean or multi-valued logic input activations for a first neural network layer and directly generates the plurality of Boolean or multi-valued logic output activations for a second neural network layer, where there may exist zero, one, or more neural network layers between the first neural network layer and the second neural network layer.

10. The circuit of claim 9, wherein the first neural network layer, the second neural network layer, and all intervening layers between the first neural network layer and the second neural network layer belong to the second plurality of neural network layers.

11. A neural network processing system comprising:
a. an array of arithmetic processing elements, each processing element configured to perform a subset of addition, multiplication, pooling, normalization, and nonlinear transformation operations for a layer in a first plurality of neural network layers; and
b. an array of logic processing elements, each logic processing element configured to perform Boolean or multi-valued logic operations for a layer in a second plurality of neural network layers.

12. The system of claim 11, wherein one of more layers in the first plurality of neural network layers or the second plurality of neural network layers are of convolutional type.

13. The system of claim 11 further comprising one or more data transformation modules existing between the outputs of the array of arithmetic processing elements and the inputs of the array of logic processing elements and vice versa, each data transformation module configured to selectively apply a transformation between data representation domains of the two arrays of processing elements.

14. The system of claim 11, wherein the logic processing elements can be custom fixed-function logic circuits in an application-specific integrated circuit, k-input look-up tables in a field programmable gate array device, or gate-level operation commands in a software-programmable logic processor, a graphics processing unit, or a general purpose central processing unit.

15. The system of claim 11, wherein the system includes one or more integrated memory units, each memory unit configured to hold any or all input and output values for each neural network layer.

16. The system of claim 11, wherein the number of input values to each neuron in one or more neural network layers in the second plurality of neural network layers is upper bounded by a pre-specified input count value for the neuron, where the pre-specified input count value is lower than the number of neurons in the preceding neural network layers that couple into the one or more neural network layers.

17. The system of claim 11, wherein at least one of the logic processing elements is configured to receive a plurality of Boolean or multi-valued logic input values for a first neural network layer and directly generates a plurality of Boolean or multi-valued logic output values for a second neural network layer, where there may exist zero, one, or more neural network layers between the first neural network layer and the second neural network layer.

18. The system of claim 17, wherein the first neural network layer, the second neural network layer, and all intervening layers between the first neural network layer and the second neural network layer belong to the second plurality of neural network layers.

19. A method of optimizing a neural network, comprising:
a. assigning neural network layers to a first plurality or a second plurality of neural network layers;
b. producing output activations of a first plurality of neural network layers by performing arithmetic operations, including addition/subtraction and multiplication to do computations of sublayers within the first plurality of neural network layers, including any required linear or convolutional computations, pooling, normalization, and nonlinear transformations; and
c. producing Boolean or multi-valued output activations of the second plurality of neural network layers by performing Boolean or multi-valued logic operations on Boolean or multi-valued input activations of the second plurality of neural network layers.

20. The method of claim 19, wherein the method comprises the step of selectively converting data representation formats for the output activations of a group of neural network layers that feed directly into a first neural network layer to a required data representation format for the input activations of the first neural network layer.

21. The method of claim 19, wherein an assignment of a neural network layer to the first plurality of neural network layers or the second plurality of neural network layers is done based on a sensitivity analysis of neural network output accuracy to the bit precision of the layer.

22. The method of claim 19, wherein a Boolean or multi-valued function of each neuron in each layer of the second plurality of neural network layers is obtained by
a. constructing a many-to-one mapping relating input activations to the output activation of a neuron; and
b. performing two-level and multi-level logic optimizations to achieve a low-cost representation of the many-to-one mapping.

23. The method of claim 22, wherein the many-to-one mapping for each neuron is obtained by enumerating all possible input activations for the neuron, sampling a training data set for the neural network, or generated synthetically.

24. The method of claim 22, wherein the Boolean or multi-valued function of each neuron describes an incompletely-specified Boolean or multi-valued logic function.

25. The method of claim 23, wherein the many-to-one mapping for each neuron is a truth table whereby each entry in the truth table comprises input activations and an output activation, the input activations are values observed at the inputs of the neuron for each input patch and each data point in the full, sampled, or synthetically-generated training data set and the output activation is produced by doing any required linear or convolutional computations, pooling, normalization, and nonlinear transformation on the input activations.

26. The method of claim 22, wherein the two-level and multi-level logic optimizations are done in such a way that the Boolean or multi-valued logic function of each neuron is only approximately equal to the truth table representation of the neuron.

27. The method of claim 23, wherein the sampling method favors sample selection around the mean value or support vector machine values of the training data set.

28. The method of claim 23, wherein the synthetic method generates new training data based on Data Shapley values of data in the training data set.
